(19) United States
(12) Patent Application Publication
(10) Pub. No.: US 2007/0133001 A1
(43) Pub. Date: Jun. 14, 2007

(54) Laser sensor having a block ring activity

(75) Inventors: James A. Cox, New Brighton, MN (US); Barrett E. Cole, Bloomington, MN (US); Rodney H. Thorland, Shoreview, MN (US); Eugen I. Cabuz, Eden Prairie, MN (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/633,872

(22) Filed: Dec. 4, 2006

Related U.S. Application Data
(63) Continuation-in-part of application No. 10/953,174, filed on Sep. 28, 2004, now Pat. No. 7,145,165.
Application No. 10/953,174 is a continuation-in-part of application No. 09/953,506, filed on Sep. 12, 2001, now Pat. No. 6,816,636.
Application No. 10/953,174 is a continuation-in-part of application No. 10/100,298, filed on Mar. 18, 2002, now Pat. No. 7,015,457.

(51) Int. Cl. G01F 23/00; G01N 21/00

(52) U.S. Cl. 356/437; 250/357.1

(57) ABSTRACT

A sensitive fluid sensor for detecting fluids and particularly trace fluids. The sensor may be adjustable for detecting fluids of various absorption lines. To effect such adjustment, a tunable laser may be used. The laser may non-tunable with a cavity having moveable mirror(s) for tuning. The laser may be an edge emitting diode, a VCSEL or other tunable on on-tunable source. The detection apparatus of the sensor may incorporate a sample cell through which a laser light may go through. The sample cell may include a tunable ring cavity block. There may be a photo detector or detectors proximate to the ring cavity. The lasers and detectors may be to electronics and/or a processor.

This application is a continuation-in-part application of U.S. patent application Ser. No. 10/953,174, filed Sep. 28, 2004, which is a continuation-in-part application of U.S. patent application Ser. No. 09/953,506, filed Sep. 12, 2001 (now U.S. Pat. No. 6,816,636).

This application is a continuation-in-part application of U.S. patent application Ser. No. 10/953,174, filed Sep. 28, 2004, which is a continuation-in-part application of U.S. patent application Ser. No. 10/100,298, filed Mar. 18, 2002 (now U.S. Pat. No. 7,015,457).

### BACKGROUND

The invention pertains to fluid detection, and particularly to laser detection of fluids. More particularly, the invention pertains to detection of fluids with a ring block cavity system.

U.S. patent application Ser. No. 10/953,174, filed Sep. 28, 2004, is hereby incorporated by reference. U.S. Pat. No. 6,816,636, issued Nov. 9, 2004, is hereby incorporated by reference. U.S. Pat. No. 7,015,457, issued Mar. 21, 2006, is hereby incorporated by reference. U.S. Pat. No. 6,406,578, issued Jun. 18, 2002, is hereby incorporated by reference. U.S. Pat. No. 6,728,286, issued Apr. 27, 2004, is hereby incorporated by reference. U.S. Pat. No. 6,310,904, issued Oct. 30, 2001, is hereby incorporated by reference. U.S. Pat. No. 5,960,025, issued Sep. 28, 1999, is hereby incorporated by reference.

There appears to be a need for a compact sensor that can detect and identify fluids with very high sensitivity, for applications related to security, industrial process control, and air quality control, and can be fabricated at low cost and expedited production with block type cavities.

### SUMMARY

The invention may be a very sensitive compact fluid sensor using a tunable laser and a block cavity.

### BRIEF DESCRIPTION OF THE DRAWING

FIG. 1a is a basic sample cell configuration with a tunable laser;

FIGS. 1b and 1c show illustrative examples of tunable edge emitting diodes;

FIG. 2 is a table of characteristic frequencies of common bond groups;

FIG. 3 is a display of results of detection and analysis of a fluid;

FIG. 4 is a table of originating wavelengths versus a delta wavelength;

FIG. 5 is a cavity-ring down spectroscophy cell with a wavelength-tunable light source;

FIG. 6 is a diagram of an adjustable wavelength vertical cavity surface emitting laser (VCSEL);

FIG. 7 is a chart showing lasing wavelength and threshold gain versus etalon displacement of VCSEL;

FIG. 8 shows field intensity versus distance in the structure of the VCSEL;

FIG. 9 is a continuation of the field intensity versus distance in the VCSEL;

FIG. 10 shows the reflectivity of the VCSEL mirrors versus wavelength;

FIG. 11 reveals the reflectance of the VCSEL resonant cavity versus wavelength; and

FIG. 12 is table of temperatures and various parameters of the VCSEL.

FIG. 13 is an example amplifier circuit for a CRD readout;

FIG. 14a shows a graph of noise versus frequency for amplifier circuit of FIG. 13;

FIG. 14b shows a graph of noise at the output versus frequency for amplifier circuit of FIG. 13;

FIG. 15 shows an active cancellation circuit connected to the amplifier;

FIG. 16a is a graph showing the double JFET charge amplifier noise composition of the non-compensated circuit of

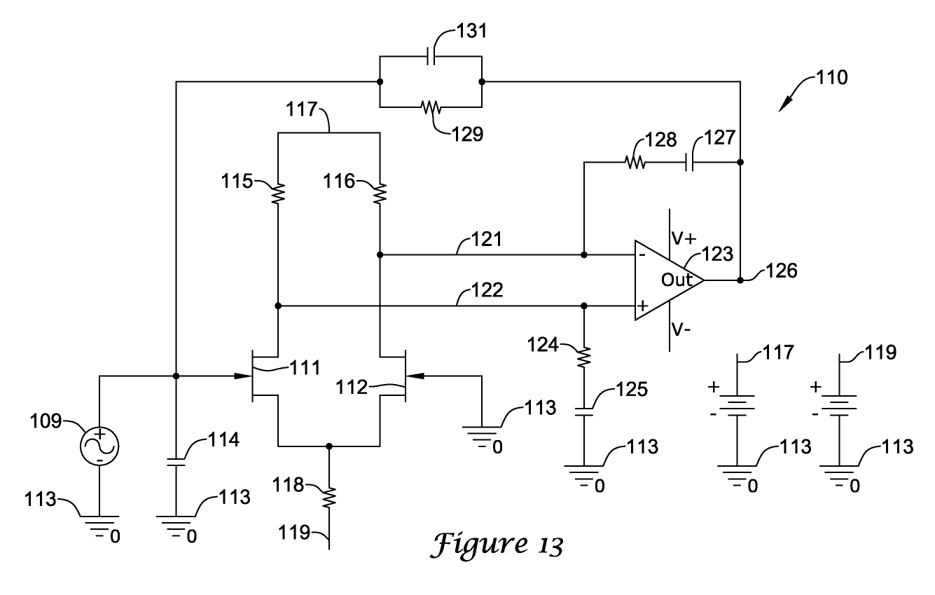

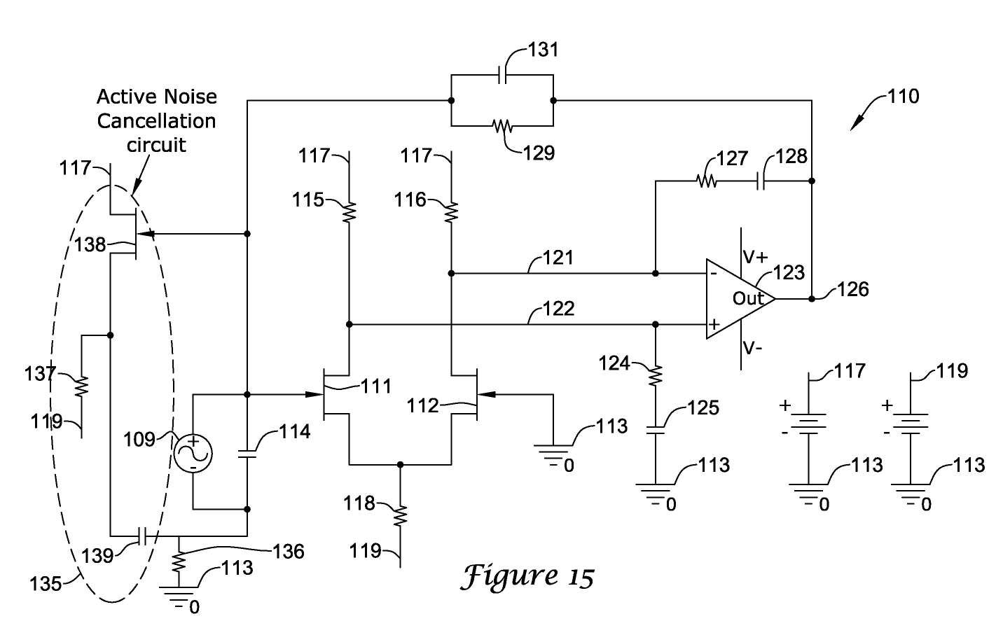

FIG. 13 and the compensated circuit of FIG. 15;

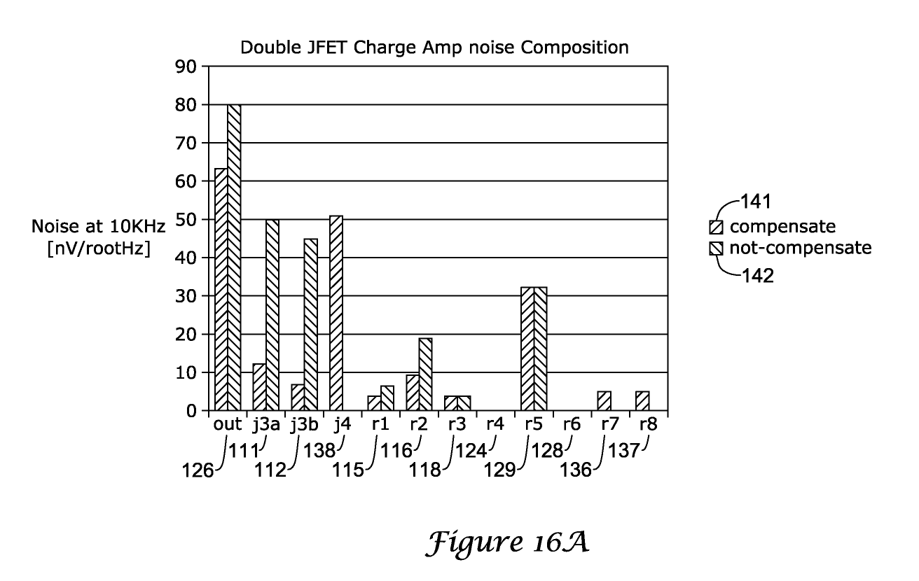

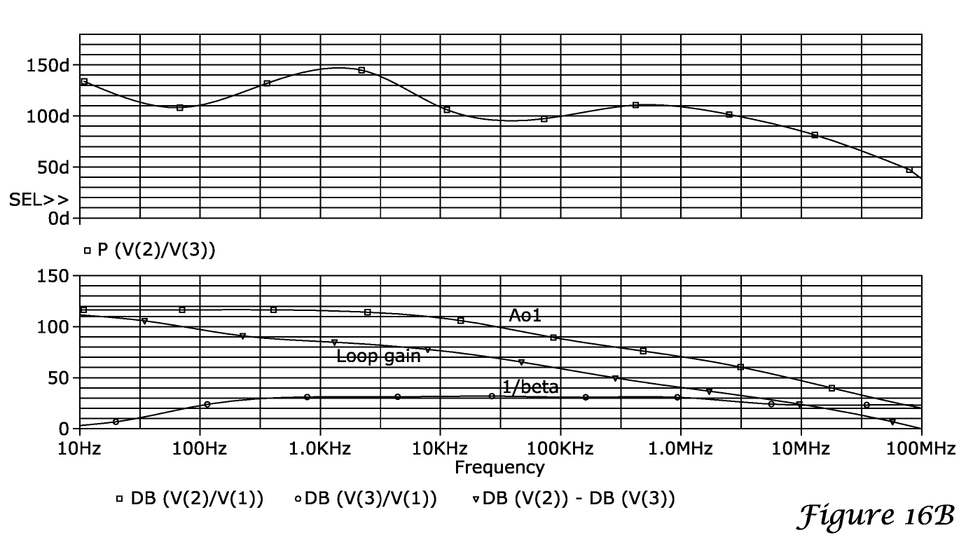

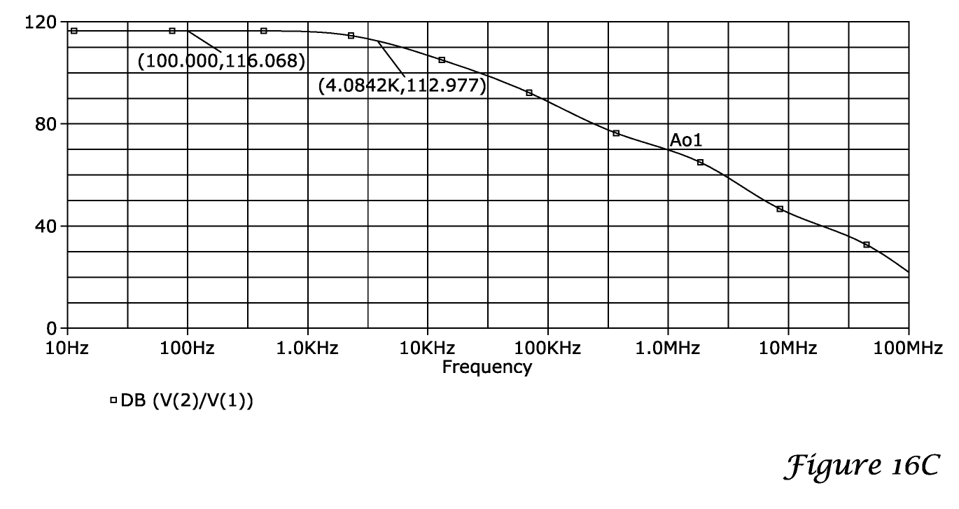

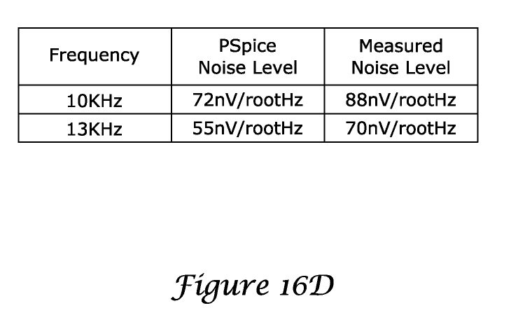

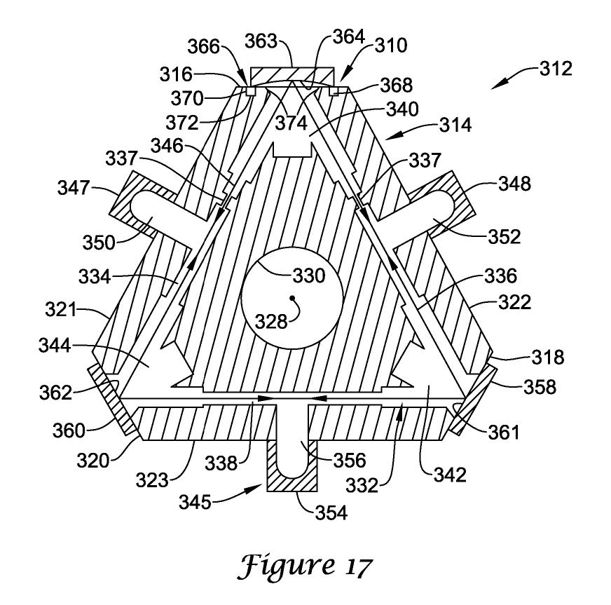

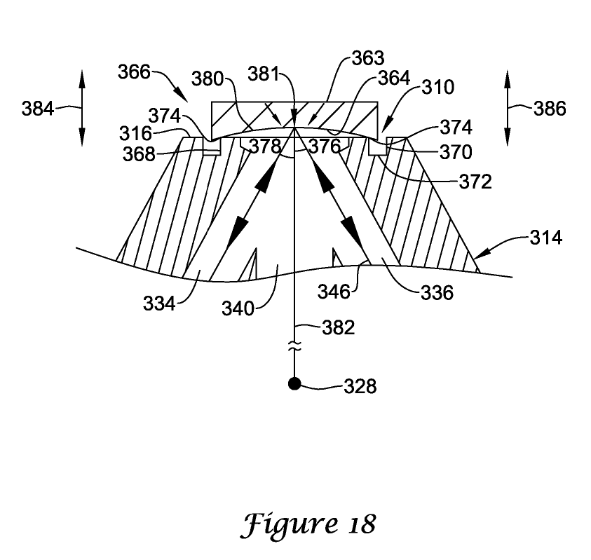

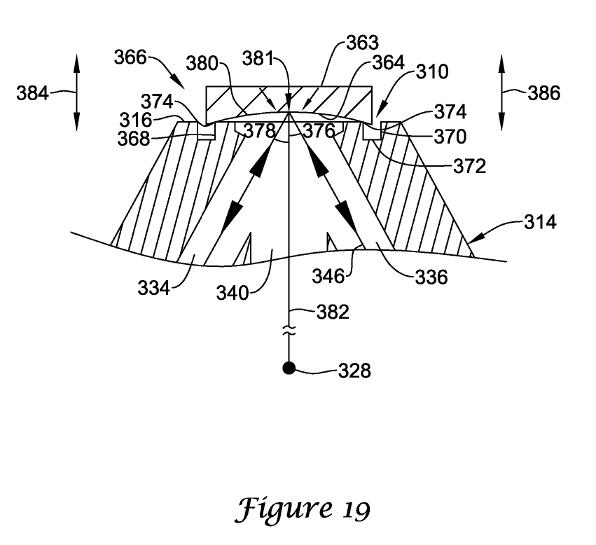

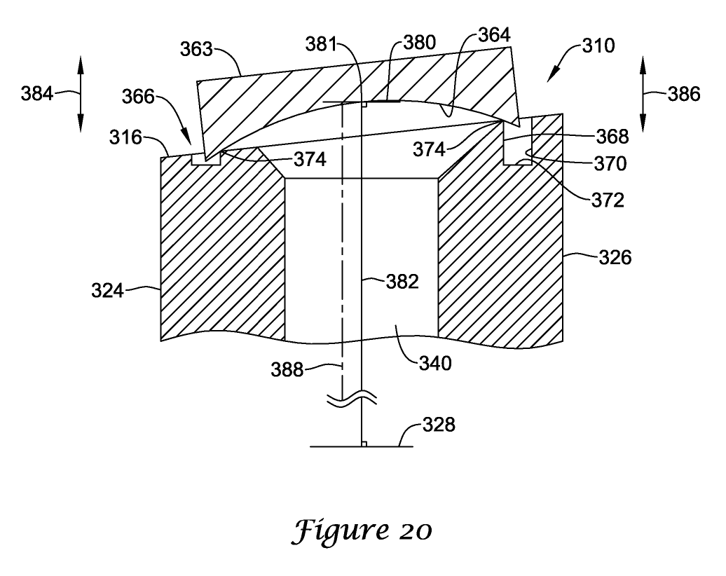

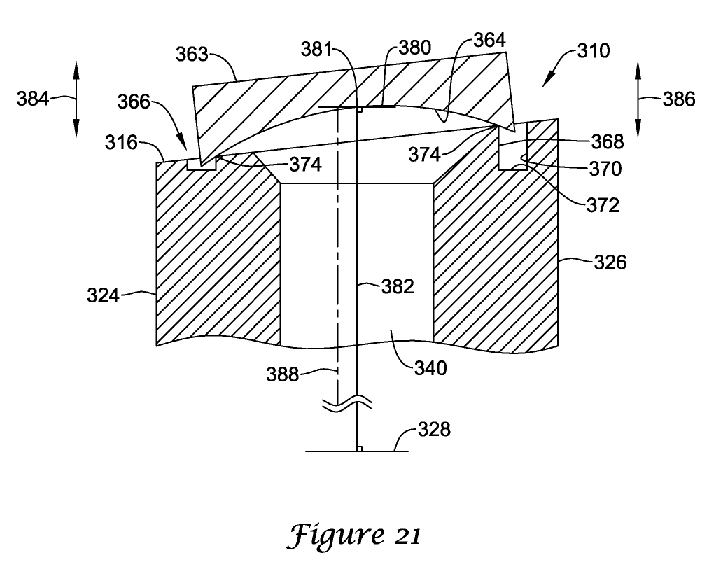

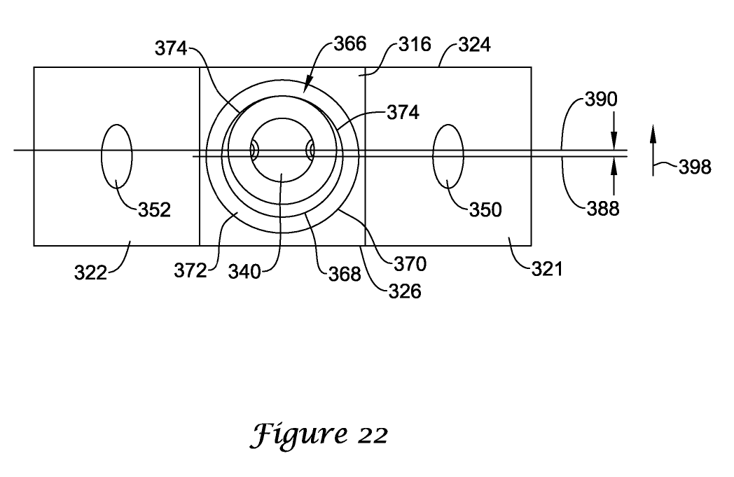

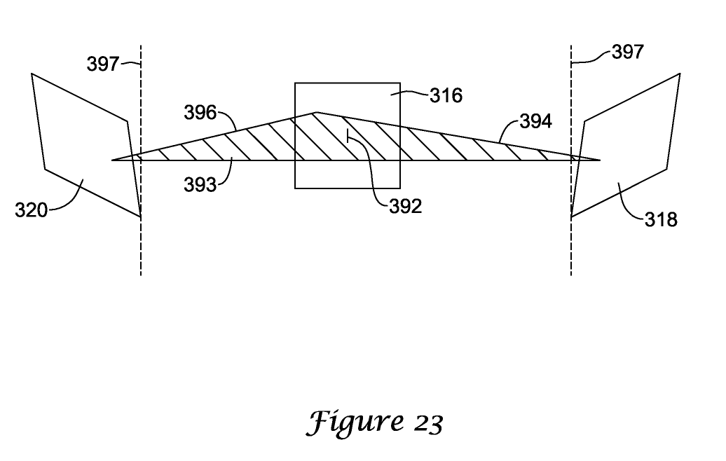

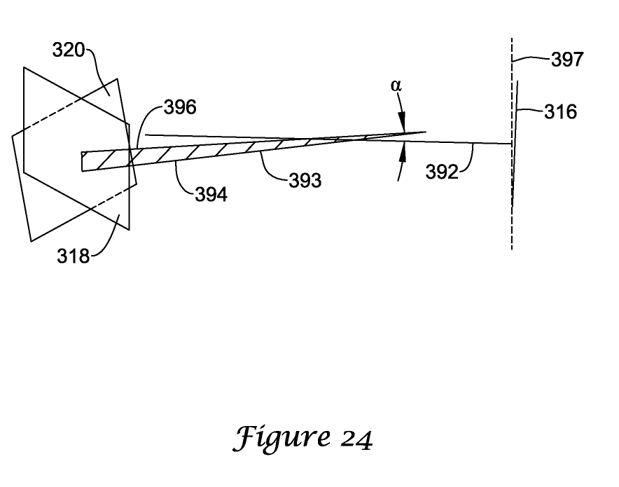

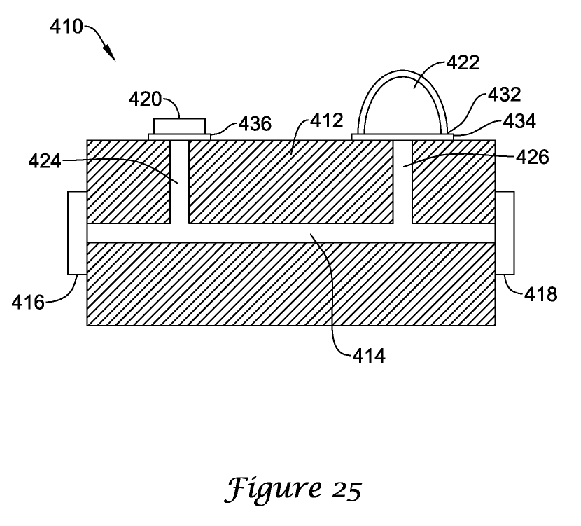

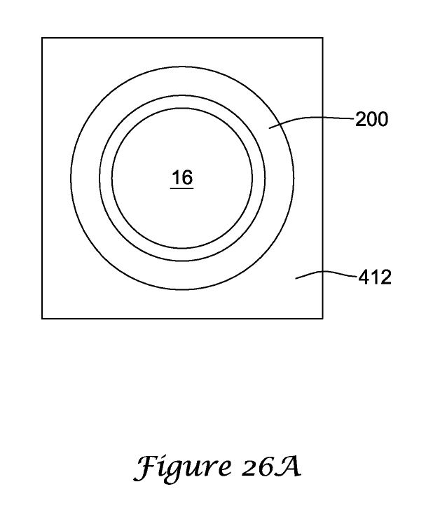

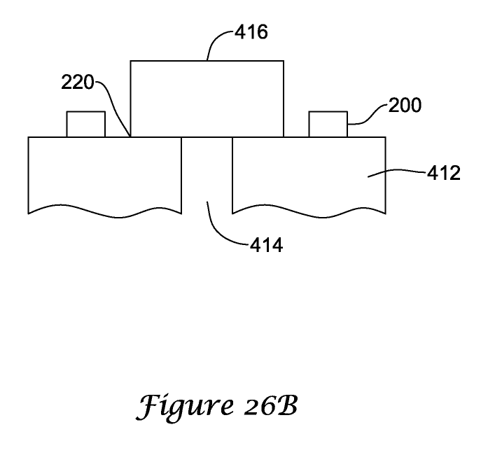

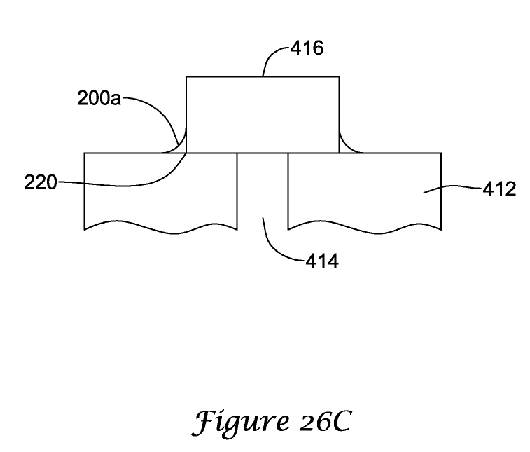

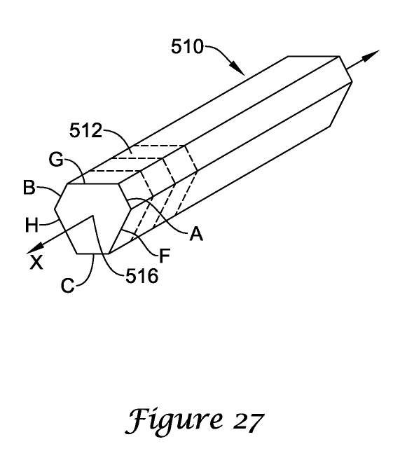

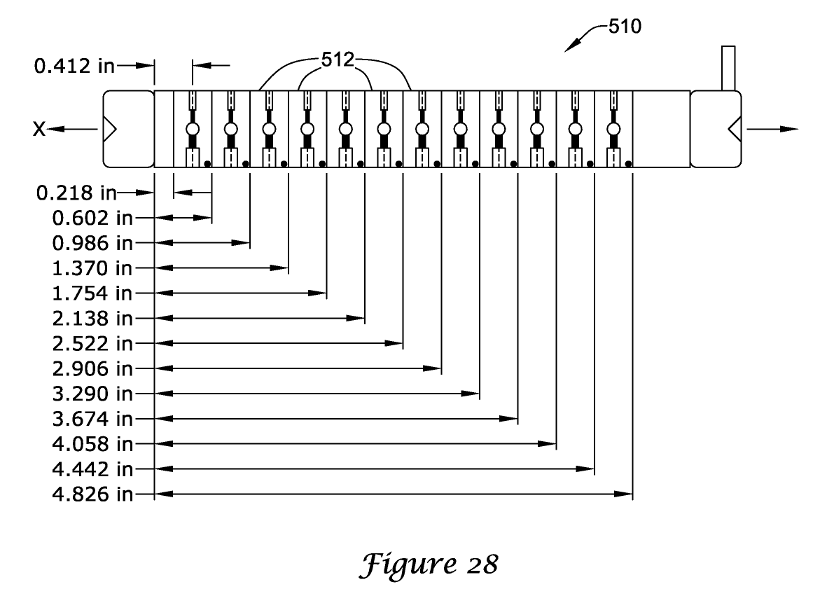

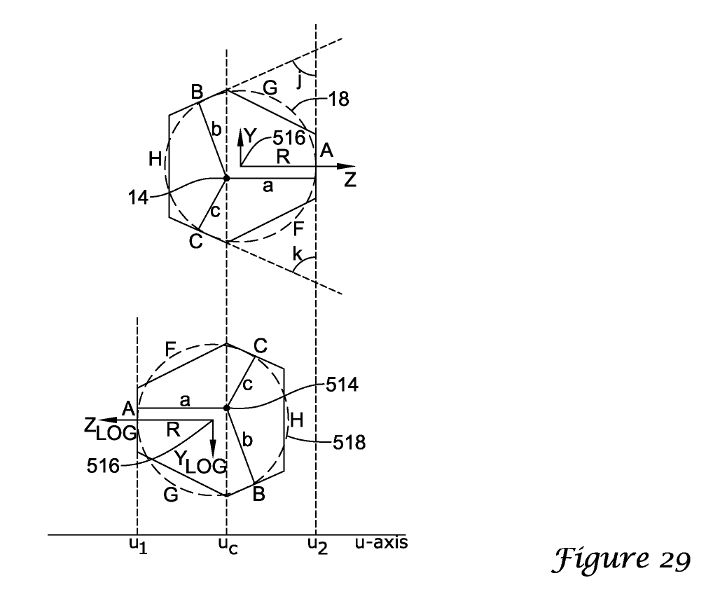

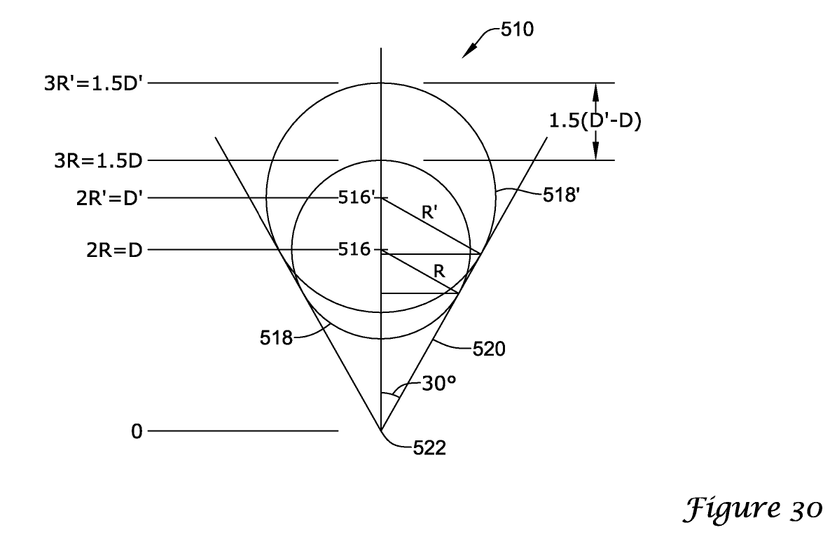

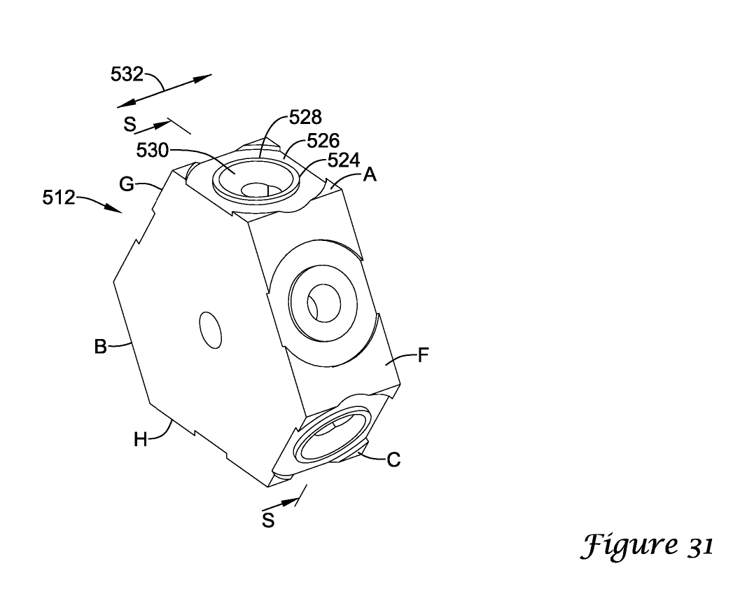

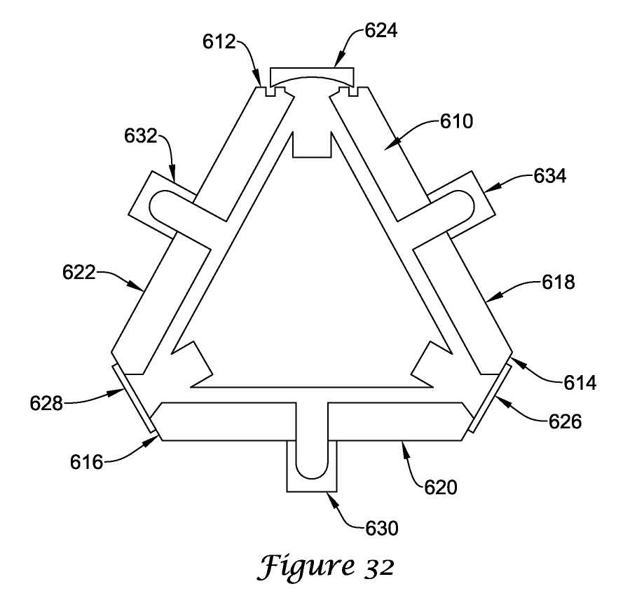

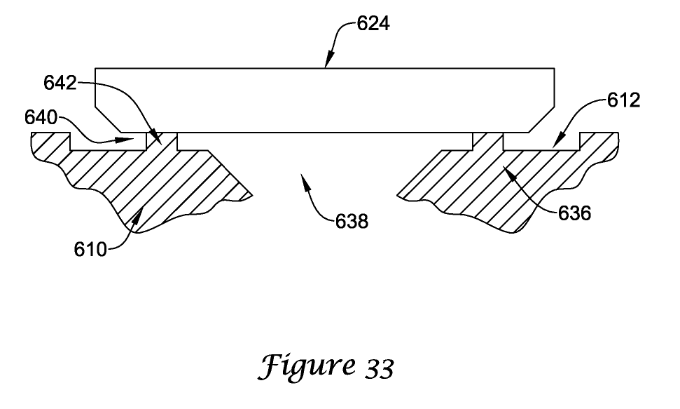

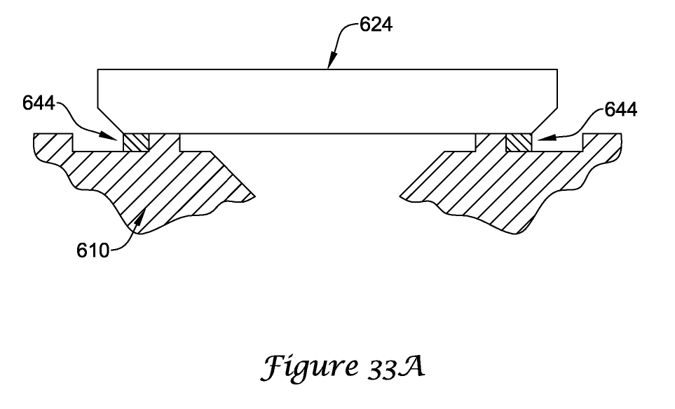

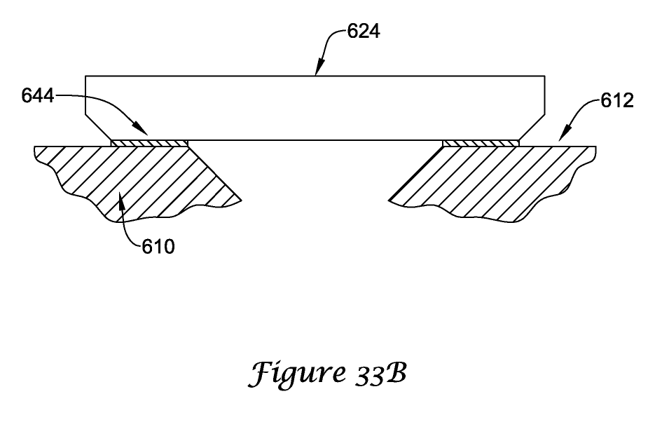

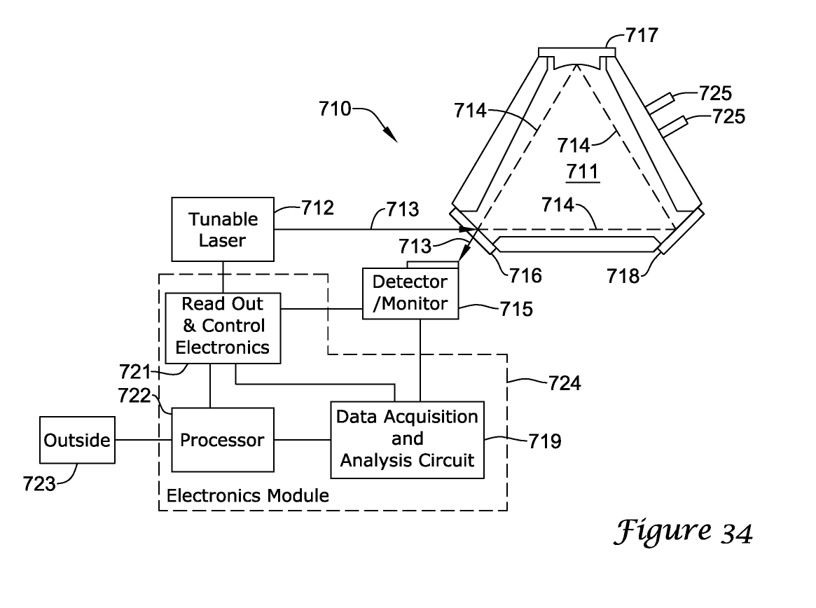

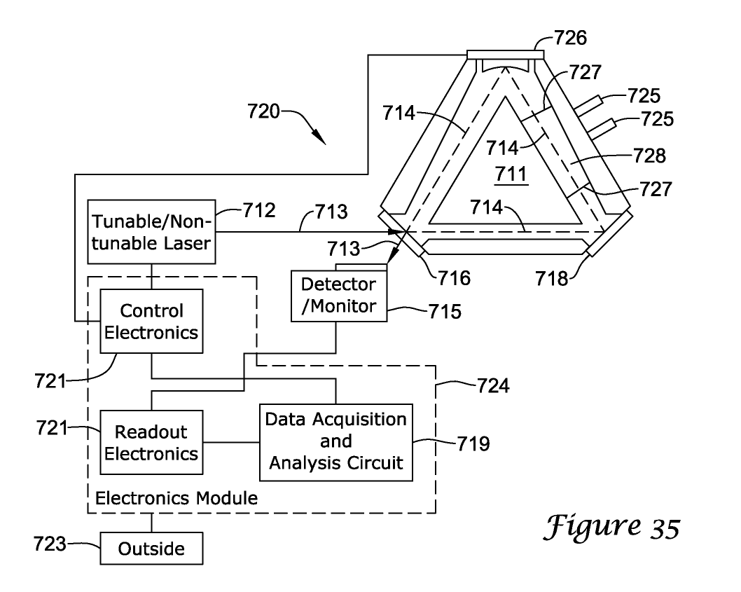

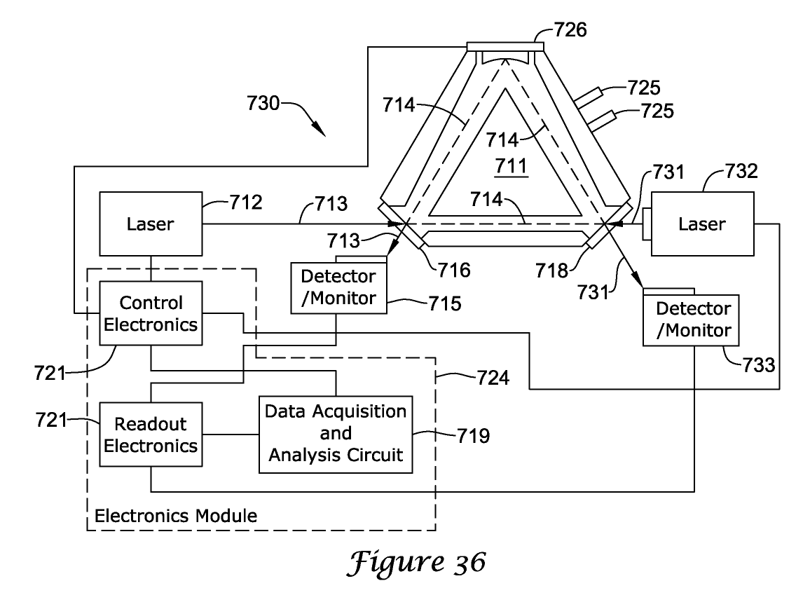

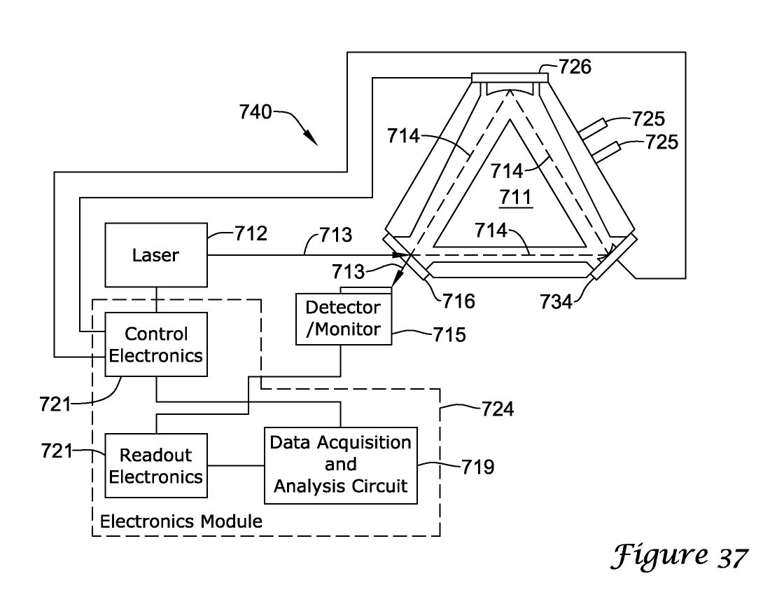

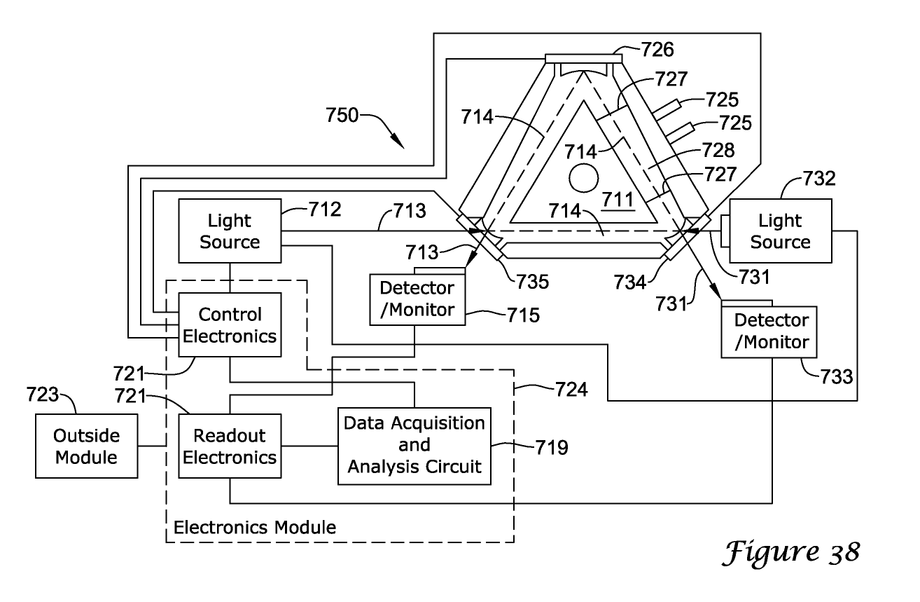

FIG. 16b shows a graph of dB versus frequency of various gains for the amplifier of FIG. 15;

FIG. 16c shows a graph of gain (dB) versus frequency for the output of the amplifier in FIG. 15;

FIG. 16d is a table comparing simulated and actual measured noise levels from a breadboard version of the charge amplifier of FIG. 13;

FIG. 17 is a plan sectional view of a laser system incorporating a mirror mounting device and approach for beam path alignment;

FIG. 18 is an enlarged partial, plan sectional view of the mirror mounting device and approach for beam path alignment with a concave mirror shown in a first orientation;

FIG. 19 is an enlarged partial, plan sectional view, similar to FIG. 18, of the mirror mounting device and approach for beam path alignment with the concave mirror shown in a second orientation;

FIG. 20 is an enlarged partial, edge sectional view of the mirror mounting device and approach for beam path alignment with a concave mirror shown in a first orientation;

FIG. 21 is an enlarged partial, edge sectional view, similar to FIG. 20, of the mirror mounting device and approach for beam path alignment with the concave mirror shown in a second orientation;

FIG. 22 is a partial edge elevational view of the mirror mounting device and approach for beam path alignment with the concave mirror removed for clarity;

FIG. 23 is a side elevational view of a block of the laser system illustrating the tilt angles of block mirror mounting surfaces for planar mirrors;

FIG. 24 is a side elevational view of the block illustrating the tilt angle of a block mirror mounting surface for a concave mirror relative to the mounting surfaces for the planar mirrors;

FIG. 25 is a cross-sectional view of a laser;

FIG. 26a is planar view of a frit seal;

FIG. 26b and FIG. 26c are cross-sectional views of the frit seal before and after the fritting process;

FIG. 27 is a perspective view of a laser system log;

FIG. 28 is a plan view of a laser system log, with the measurement points indicated;

FIG. 29 is a diagram illustrating a measurement approach;

FIG. 30 is a diagram illustrating the difference in elevation of the opposite ends of a log in a V-block measurement;

FIG. 31 is a perspective view of a laser system block showing a mirror mounting device;

FIG. 32 shows a simplified cross-section of a laser system block assembly;

FIG. 33 is an expanded cross-section view of the one of the components and the laser system body;

FIG. 33a shows a structure with the mirror bonded in place;

FIG. 33b shows another structure the bonded mirror;

FIG. 34 shows a laser fluid sensor having a basic block type ring cavity;

FIG. 35 shows a laser fluid sensor having a tunable block type ring cavity;

FIG. 36 shows a laser fluid sensor with a light source and detector configuration for counter-propagating beams;

FIG. 37 shows a laser fluid sensor having a block type ring cavity tunable with several moveable mirrors; and

FIG. 38 shows a laser fluid sensor with a light source and detector configuration for counter-propagating beams in a block type ring cavity tunable having multiple moveable mirrors.

### DESCRIPTION

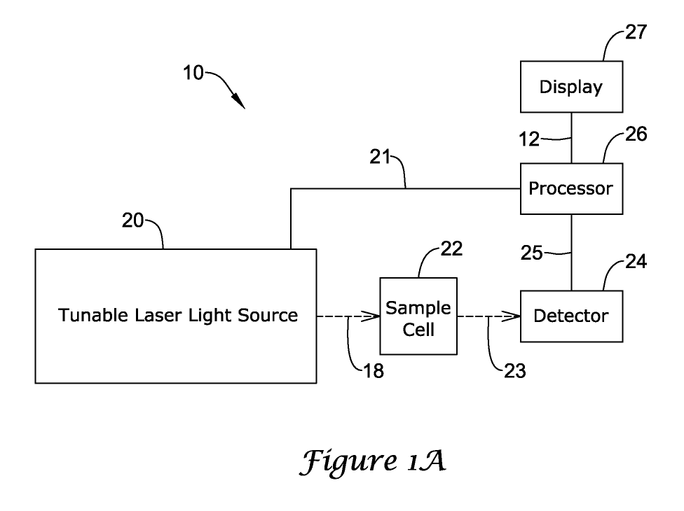

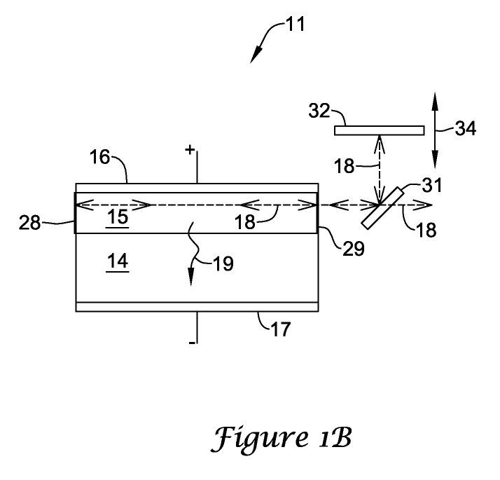

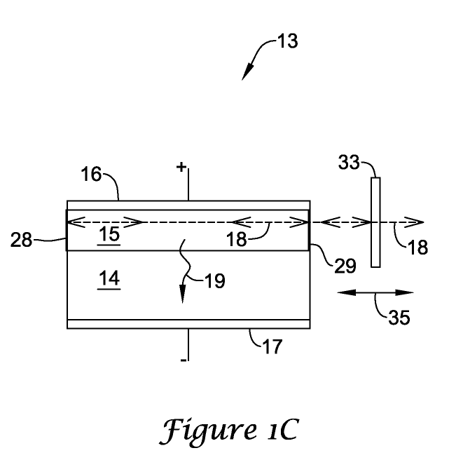

FIG. 1a reveals a configuration 10 of a cell 22 with a tunable laser light source 20. The tunable laser 20 may incorporate a diode laser, a vertical cavity surface emitting laser (VCSEL), or other type of tunable laser. The tunable laser 20 may have its wavelength varied for detecting and analyzing various fluids. The wavelength may be pre-programmed or varied real-time during detection and analysis.

The present invention may include a tunable laser or other tunable source coupled with a device to directly detect molecular absorption at specific wavelengths addressable with the tunable laser. One way is to tune the lasing wavelength of a laser diode, such as, an edge emitting diode or VCSEL. A way to tune the lasing wavelength is to use a MEMS-actuated etalon having a mirror of a laser resonant cavity, and a thermally-tuned microbridge mirror in a Fabry-Perot cavity. The tunable laser may be coupled into one of two detection cells capable of directly sensing absorption in the gas of interest. This device may be an opto-acoustic cell or a ring-down cavity. The ring cavity may have a closed internal path which may have the form of a polygon. The laser may enter the cavity at one point and go around through the cavity several times before is fades away due to losses. This decrease in amplitude of the laser or other light beam, the time of the decrease and the profile of the decrease may provide information about a gas possibly in the cavity.

The opto-acoustic cell may be used for lower cost and lower performance applications. The ring-down cavity may be implemented into a cavity ring-down spectrometer. The ring-down spectrometer may be used in applications requiring the highest sensitivity. The tunable laser may be needed for identification of specific molecular species of interest. The ring-down cavity may be implemented with certain methods and technology from a block of suitable material. The ring-down cavity may be a ring cavity block.

The detection may be of a fluid, i.e., a gas or liquid. The description may, for illustrative purposes, deal with gas detection and discrimination. The sensitivity of the sensor may be application dependent. Significant targets of the sensor may be explosives and chembio agents. The sensitivity of the sensor may range from ppb to ppt levels. The size of the sensor may be only about one to three cubic inches, i.e., about 15-50 cm³.

The spectral absorption of molecular vibration/rotation modes may be expressed as A=SDL, where A is absorbance, S is a molecular cross-section, D is molecular density and L is path length. Sₚₑₐₖ(λ) may vary by 2-3 orders of magnitude in the waveband of 1 to 8 microns. Sₚₑₐₖ(λ) may be the largest for the fundamental vibration/rotation modes (generally in the 3 to 8 micron band). Sₚₑₐₖ(λ) may be the smallest for harmonics (generally in the 1 to 2 micron band).

Examples of Sₚₑₐₖ(λ) may include:
CO₂(4.3 μm)˜1×10⁻¹⁸(cm²/mol)cm⁻¹(max.>1−8 μm)
H₂O(1.4 μm)˜2×10⁻²⁰(cm²/mol)cm⁻¹(max.=3×10¹⁹ at ˜5.9 μm)
NH₃(1.53 μm)˜2×10⁻²¹(cm²/mol)cm⁻¹(max.=2.2×10⁻²⁰ at ˜3.0 μm)
The spectral signature (S(λ)) may indicate a species discrimination.

The threshold limit values (TLVs) may be important to know since one objective is detection of lethal chemicals. The following are examples of such chemicals and their threshold limits. Blood agents may include arsine (Ar) (ArH₃), which may be a blood type agent having a TLV of about 50 ppb. Cyanogen chloride (CClN) may be a blood type agent having a TLV of about 300 ppb. Hydrogen cyanide (CHH) may be a blood type agent having a TLV of about 4700 ppb. Chloropicrin (PS) (CCl₃NO₂) may be a choking type of agent having a TLV of about 100 ppb. Mustard (HD) (C₄H₈Cl₂S) may be a blister type of agent having a TLV of about 0.5 ppb. Methyl phosphorothioate (VX) (C₁₁H₂₆NO₂PS) may be a nerve type of agent having a TLV of about 0.8 ppt. Isopropyl methyl phosphonofluoridate (GB, sarin) (C₄H₁₀FO₂P) may be a nerve type of agent having a TLV of 16 ppt. Ethyl N,N-dimethyl phosphoramidocyanidate (GA, tabun) (C₅H₁₁N₂O₂P) may be a nerve type of agent having a TLV of abut 14 ppt. Pinacoly methyl phosphonofluoridate (GD, soman) (C₇H₁₆FO₂P) may be a nerve type agent having a TLV of about 3 ppt. These are the kinds of chemicals that the present sensor may detect and identify. These are examples of chemicals of concern along with these TLV levels that the present sensor may detect. TLV may represent the maximum airborne concentrations of substances that in general may be exposed day after day during normal workers' hours with no adverse effect.

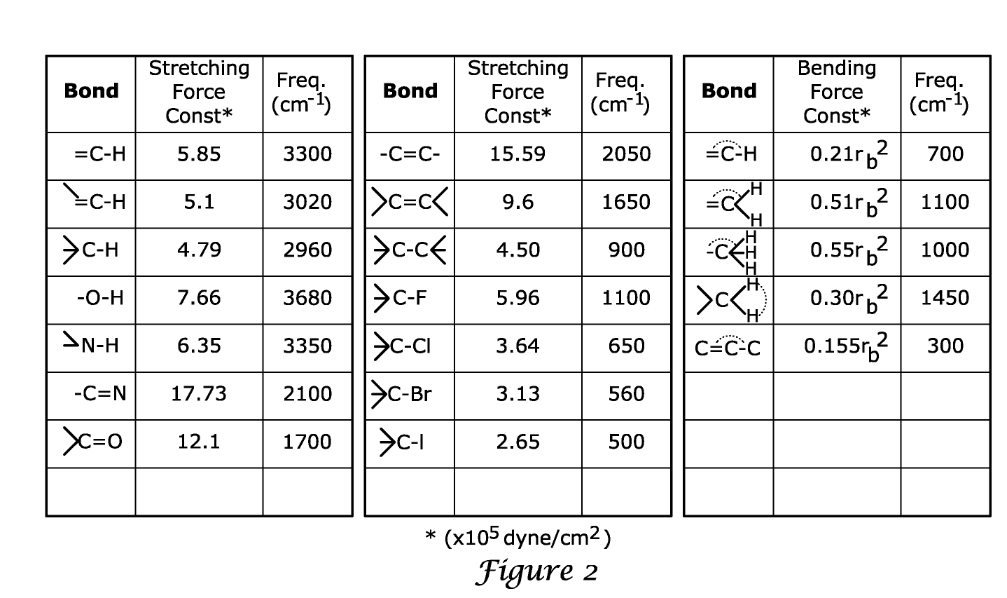

A tunable laser module 20, as shown in FIG. 1a, may be used to discriminate molecular species. Typically, common bond groups may have characteristic absorption regions. However, each molecule may have a unique vibrational spectrum. The characteristic absorption regional and the vibrational spectrum information may be useful for identifying species of substances. FIG. 2 has a table of approximate characteristic frequencies of common bond groups.

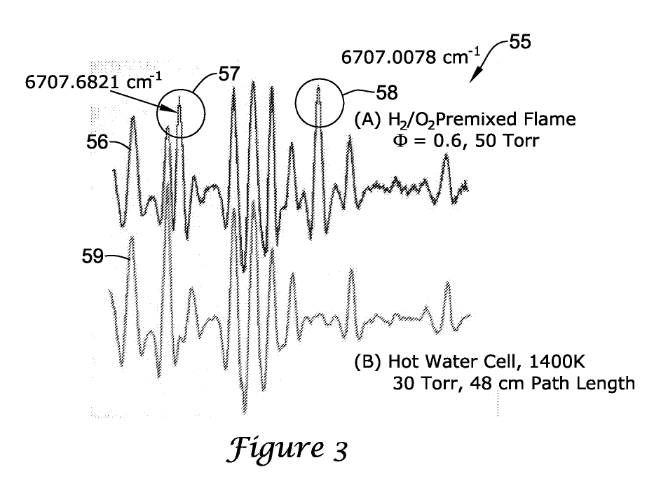

In FIG. 1a, a laser 20 may emanate light 18 of a particular wavelength. From laser 20, light 18 may propagate through sample cell 22. A resultant light 23 may emanate from sample cell 23 to detector 24. Electrical signals 25 from detector 24 to a controller 26 may be the electrical equivalent of light 23. Controller 26 may process the signals 25 from detector 24 and send resultant signals 12 to display 27. As an illustrative example, display 27 may exhibit a graphical picture as shown in FIG. 3. Also, processor 26, via signals 21 to source 20, may tune light source 20 to an absorption line of the fluid (e.g., gas) in the sample cell 22. Sample cell 22 may incorporate a device likewise tuned to the absorption line, such that the light in the device has an appropriate phase relationship with the light from the light source. Such tuned combination improves the sensitivity of the device 10 in an exceptional manner.

FIGS. 1b and 1c reveal examples of edge emitting laser 11 and 13 respectively. These lasers may be used as the source 20 of configuration 10 of FIG. 1a. Lasers 11 and 13 may have some similarity of structure such as a substrate 14 with a cavity 15 formed on the substrate 14. Cavity 15 may have a mirror 28 formed at one end and a mirror 29 formed at the other end. In cavity 15 may be a quantum well structure. Formed on cavity 15 may be a metal layer 16 formed on the surface of cavity 15 opposite of the surface adjacent to the substrate 14. On the other surface or bottom of the substrate may be a metal layer 17 formed. Layer 16 may be an electrode for a positive potential of an electrical connection and layer 17 may be an electrode for a negative potential of the electrical connection. Applying these potentials to the electrodes may result in a current 19 flowing from layer 16 through cavity 15 and substrate 14 to layer 17. This may result in light being 18 generated in resonate between the mirrors 28 and 29 of cavity 15 with a portion of light 18 being emitted out of one or both ends of the cavity 15. In lasers 11 and 13, mirror 28 is very highly reflective and mirror 29 is only slightly less reflective than mirror 29, so as to let light 18 be emitted out of the cavity 15 through mirror 29. Mirror 29 may have an anti-reflective coating.

The differences between lasers 11 and 13 appear between their tuning structures. In FIG. 1b, some of light 18 may be reflected by a splitter 31 to an adjustable mirror 32 or etalon. Light 18 reflected back by mirror 32 may be reflected back at least partially into the cavity 15 by splitter 31. The distance of travel of light 18 being reflected by mirror 31 may affect the resonant frequency of the cavity 15 and thus the wavelength of the light 18 emanating from the cavity 15 and passing through the splitter 31 as an output of laser 11. Thus, the wavelength of the output light of laser 11 may be changed or tuning by a movement of mirror 32 in directions 34 towards or from splitter 31.

The tuning structure of laser 13 in FIG. 1c may have a mirror 33 situated proximate and parallel to the mirror 29 at the end of cavity 15. Light 18 may emanate from cavity 15 through mirror 29 towards a partially transmissive mirror 33. Some of the light 18 may be reflected back from mirror 33 into cavity 15. The distance of mirror 33 from cavity 15 at mirror 29 may affect the resonant frequency of the cavity and thus the wavelength of the light 18 emanating from laser 13 through mirror 33 from cavity 15. Thus, the wavelength of the output light of laser 13 may be changed or tuned by a movement of mirror 33 in directions 35 towards or from mirror 29 of cavity 31.

FIG. 3 shows the results of an observation 55 from display 27 which shows an illustrative view of the detector 24 results of light 23 exiting from sample cell 22. Waveform 56 is that of a H₂/O₂ premixed flame where Φ=0.6 under a pressure of 50 Torr. Two peaks of interest are peak 57 at 6707.6821 cm⁻¹ and peak 58 at 6707.0078 cm⁻¹. Waveform 59 is that of a hot water cell at 1400° K., a pressure of 30 Torr and a 48 cm path length.

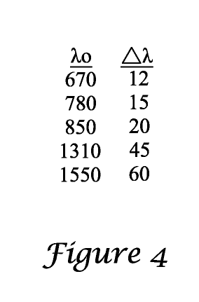

FIG. 4 is a table of the wavelength of an emanating light and the resultant delta of wavelength, at various wavelengths of the originating light.

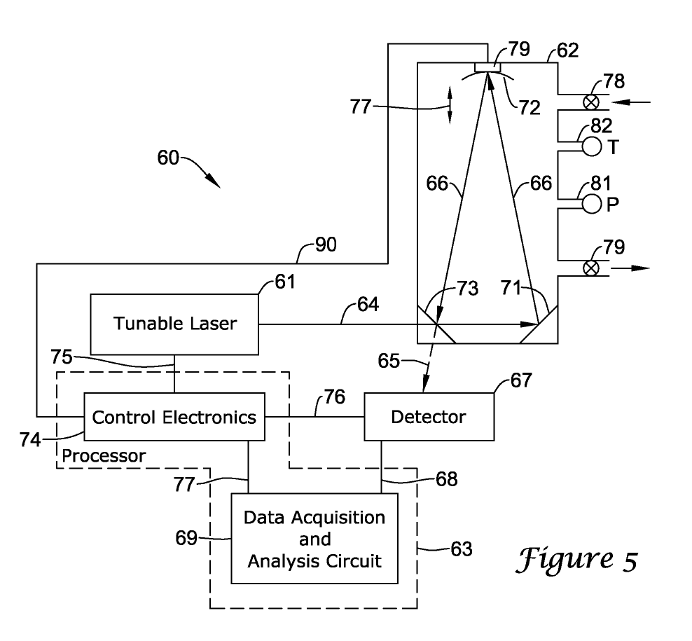

As shown in FIG. 5, a tunable laser 61 may be coupled to a three mirror optical ring-down cavity 62. One of the mirrors, e.g., mirror 72, may have a slight and high radius curvature to improve stability so that a light beam 66 does not walk off the cavity. Cavity 62 may be a block ring cavity or, alternatively, a ring cavity akin to a cavity of laser system though not necessarily having two lasers going through it. Cavity 62 may have two, three, four mirrors, or any other number of mirrors providing a light path selected from various possible routes for light in the cavity. There may be an analog detection circuit 63 to extract the ring-down rate from an exponentially decaying ring-down waveform. A technique may be used to measure trace concentrations of gases in the near infrared region using a continuous wave excitation 64 of a cavity-ring down spectroscopy cell or cavity 62 (CW-CRDS). Cavity ring-down spectroscopy may be an absorption technique in which light 64 is coupled into a high finesse optical resonator 62. The cavity 62 may be tuned to the absorption line of the gas in the cavity being sensed and quantitatively measured. Cavity 62 may be tuned such that light 66 is in phase with the incoming light 64. This tuning, such as adjusting the path length of light 66, may be applicable to other kinds of cavities, such as those with two mirrors, four mirrors, and the like. Tuning the cavity with mirror 72 adjustment 77 with an actuator 79 may be one way of adjustment. Similarly, a light source 61 may have an output wavelength tuned to the absorption line of the gas in the cavity. By monitoring the decay rate of the light 66 inside the cavity with detection circuit 63 which includes a detector 67, one may determine a concentration of a particular gas in the cavity 62. The near infrared light 65 detected may contain vibrational overtone transitions and forbidden electronic transitions of various atmospheric species of gas. System 60 may obey Beer's law and provide a highly accurate concentration determination. The effective path length of the light 66 in the cavity may be about a hundred times larger than the physical size of the cell 62 due to highly reflective dielectric mirrors 71, 72 and 73. Mirror 72 may have an adjustment 77 for tuning the path length of cell 62 for light 66.

There may be fast trace gas impurity measurements of critical molecules such as H₂O, CO, NH₃, HF, HCl, CH₄ and C₂H₂. Such measurements may be made in seconds. Trace moisture concentration may be measured at levels from parts per billion (ppb) to parts per trillion (ppt).

Tunnel laser 61 may send a continuous wave (or possibly pulsed) light signal to cell 62. Signal 64 may be regarded as a signal 66 that is reflected around in cell 62 from mirror 71, to mirror 72, to mirror 73, to mirror 71 and so on until the signal 66 diminishes. Some light 65 may leave cell 62 and impinge detector 67. Detector 67 may convert light signal 65 to an electrical signal 68 that goes to a data acquisition and analysis unit 69. Control electronics 74 may send control signals 75, 76 and 77 to tunable laser 61, detector 65 and data acquisition and analysis unit 69, respectively. Also, a control signal 90 may be sent to a moveable support 79 of mirror 72 to provide tenability of the path for light 66. Support 79 may be a piezoelectric transducer to allow tuning and modulation of the path length of cell 62.

One may detect a certain fluid using a laser tuned on a transition band, near a particular frequency. Using system 62, one may be able to measure the concentration of the fluid in some medium. The certain fluid and associated medium may enter a port 78 and exit a port 79. Port 81 may be for a connection to a pump. Port 82 may be used for a gauge. One or more hollow optical fibers to and from the ring cavity may be used provide gas to take gas form the ring cavity. The gas may be compartmentalized in the cavity with Brewster windows.

The system 60 may provide for an intrinsic measure of absorption. The CRDS sensitivity may equal
(Δt/t)(Lₒₚₜ/L_{cav})(1/F_{acq})^{1/2}
Another relationship may be:
Lₒₚₜ˜L_{cav}/[nₘᵢᵣᵣₒᵣ(1-R)]˜10⁴L_{cav}
Typical sensitivity may be at about 10⁻⁶ to 10⁻¹⁰ cm⁻¹ for multimode light and about 10⁻⁹ to 10⁻¹² cm⁻¹ for single mode light.

The system 62 may be built on the strengths of a MEMS etalon, various laser system technologies and VCSELs.

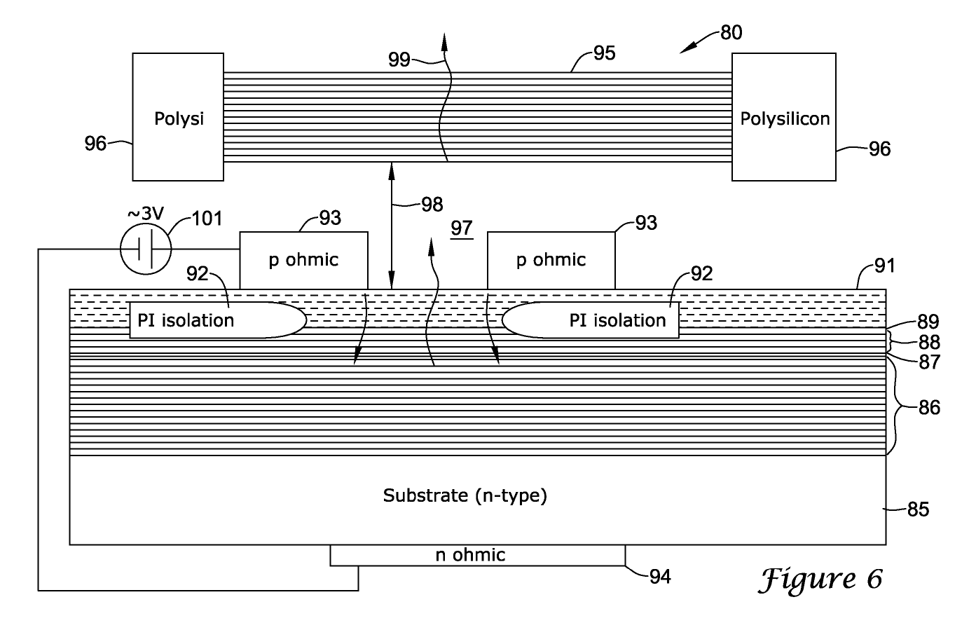

FIG. 6 shows a tunable VCSEL 80. It may have an n type GaAs substrate. On substrate 85, may be a bottom distributed Bragg reflector (DBR) mirror 86. Mirror 86 may be an n type having 35.5 periods of AlAs/GaAs graded layers. On mirror 86, may be an n type spacer 87. On active region 88 may be situated on n spacer 87. Active region 88 may have three GaInAsN/GaAs quantum wells with barriers between them. A p type spacer 89 may be situated on active region 88. On active region 88 may be a layer 91 of p type GaAs for current spreading. Layer 91 may have a thickness of about 1200 nm. There may be a proton implanted isolation 92 for current confinement. Isolation 92 may be implanted in layer 91 and possibly in a portion of p type spacer 89. Situated on layer 91 may be a p type ohmic contact 93. On the bottom of substrate 85 may be an n type ohmic contact 94.

Situated above layer 91 and contact 93 may be a p type distributed Bragg reflector mirror 95. Mirror 95 may have 4.5 periods of TiO₂/SiO₂ layers. Mirror 95 may be supported by a polysilicon structure 96 over layer 91 with an air gap 97 between mirror 95 and layer 91. The air gap 97 may have a distance or linear dimension 98 of (2 m+1)/4. The cavity formed by mirrors 86 and 95 may be changed by adjusting mirror 95 relative to mirror 86. This adjustment of distance 98 may affect the wavelength of the light 99 output from VCSEL 80. Mirror 95 may be effectively an etalon of VCSEL 80.

To operate VCSEL 80, a voltage from a source 101 may have a positive polarity applied to the p ohmic contact 93 and the other polarity applied to n ohmic contact 94. The voltage source 101 may be about three volts. The connection of source 101 to VCSEL 80 may cause a current to flow downwards from contact 93 through layer 91 with isolation 92, and through other components of the VCSEL to contact 94. Consequently, light 99 may be emitted upwards from active region 88 through spacer 89, layer 91, and air gap 97. Some of the light 99 may be reflected within the cavity between mirrors 86 and 95.

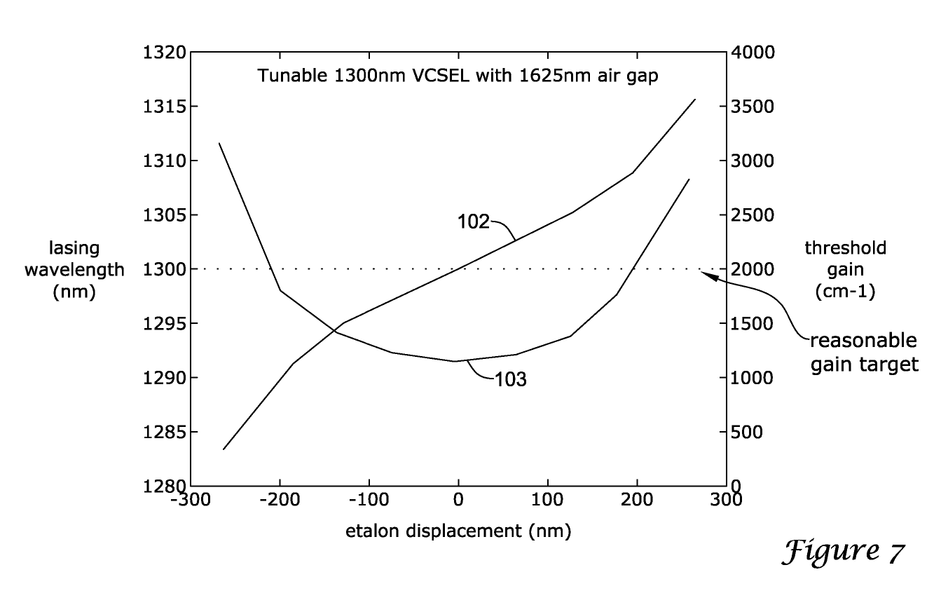

FIG. 7 is a graph showing tunability and threshold gain versus etalon displacement 98 change from the displacement setting for 1300 nm of VCSEL 80 with a 1625 nm air gap. Curve 102 shows the lasing wavelength versus etalon displacement. Curve 103 shows the threshold gain (cm⁻¹) versus etalon displacement. The displacement may be limited to ±200 nm.

A reasonable gain target may be 2000 cm⁻¹. There is about a 20 nm tuning range from about 1290 nm to 1310 nm. The tuning range may be limited by the bottom mirror 86 Δn. The tuning efficiency may be about 5 percent.

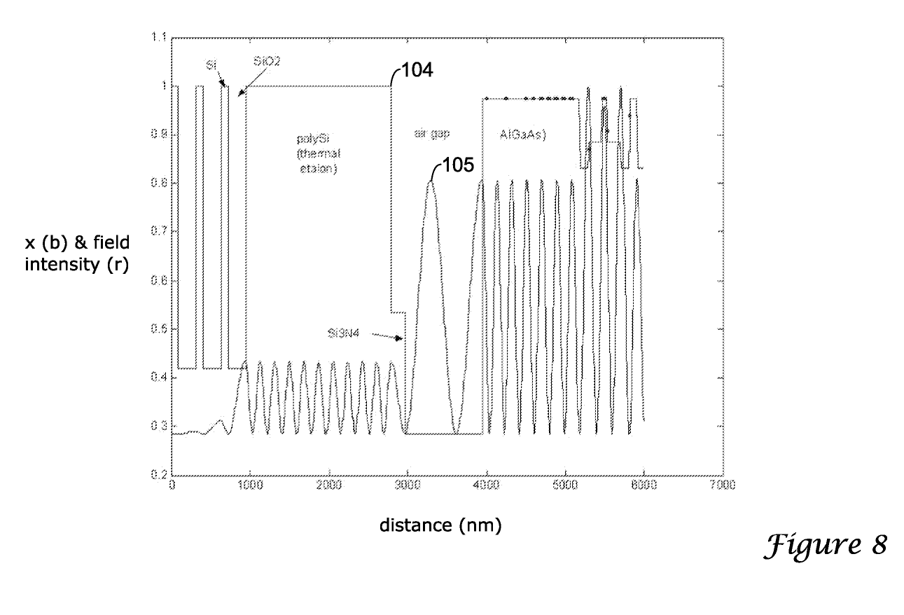

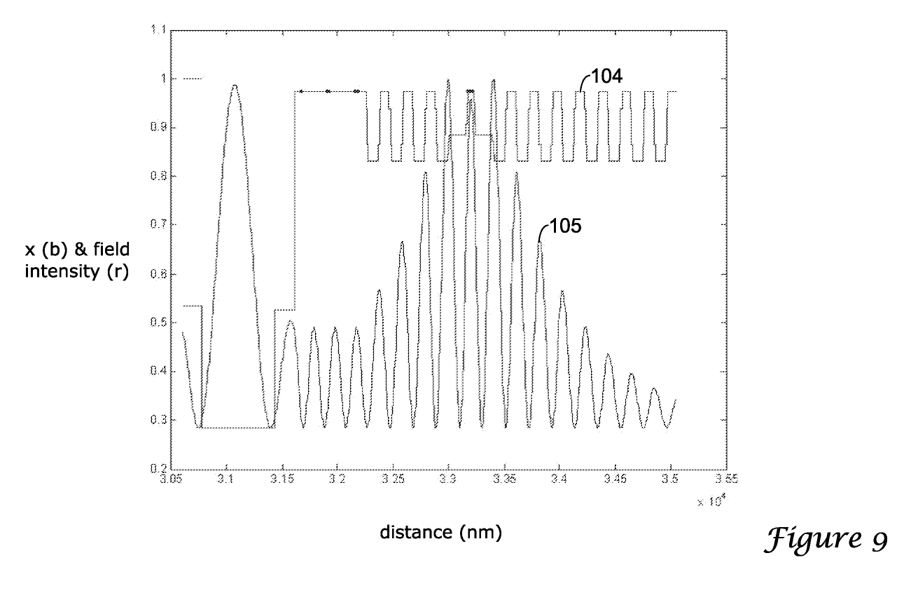

FIG. 8 shows the side profile of material with x(b) and field intensity (r) versus distance nm through the VCSEL 80. Curve 104 shows the material profile through the VCSEL 80 with the Si and SiO₂ layers, the polysilicon (thermal etalon), the Si₃N₄, the air gap, and the AlGaAs structure. Curve 105 shows the field intensity relative to distance into the structure of VCSEL 80. FIG. 9 is a contamination of x(b) and field intensity versus distance into VCSEL 80 structure, and continues at about the air gap portion of FIG. 8, as indicated by the distance axis.

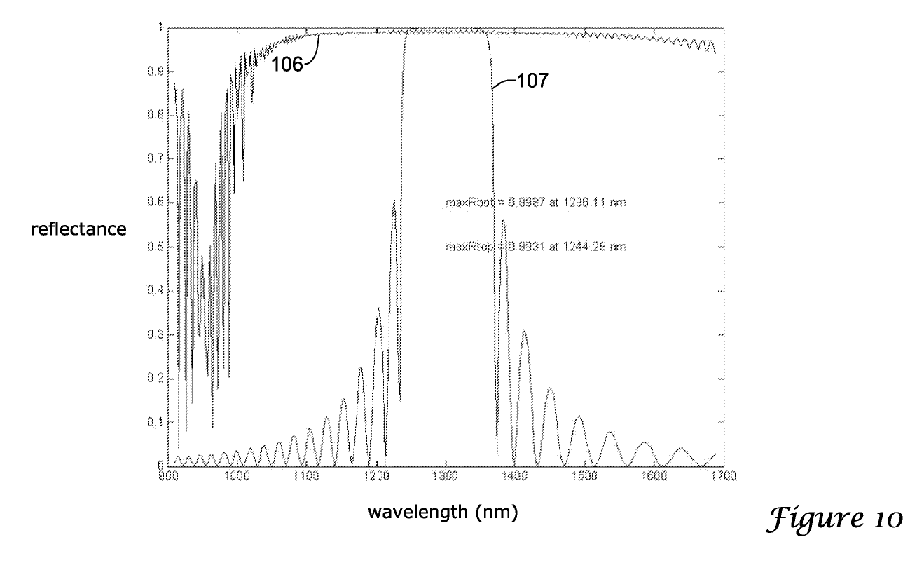

FIG. 10 reveals the reflectance versus wavelength curves 106 and 107 for the top mirror and the bottom mirror, respectively, of VCSEL 80. The maximum reflectance for the top mirror is about 0.9931 at 1244.29 nm wavelength. The maximum reflectance for the bottom mirror is about 0.9987 at 1296.11 nm wavelength.

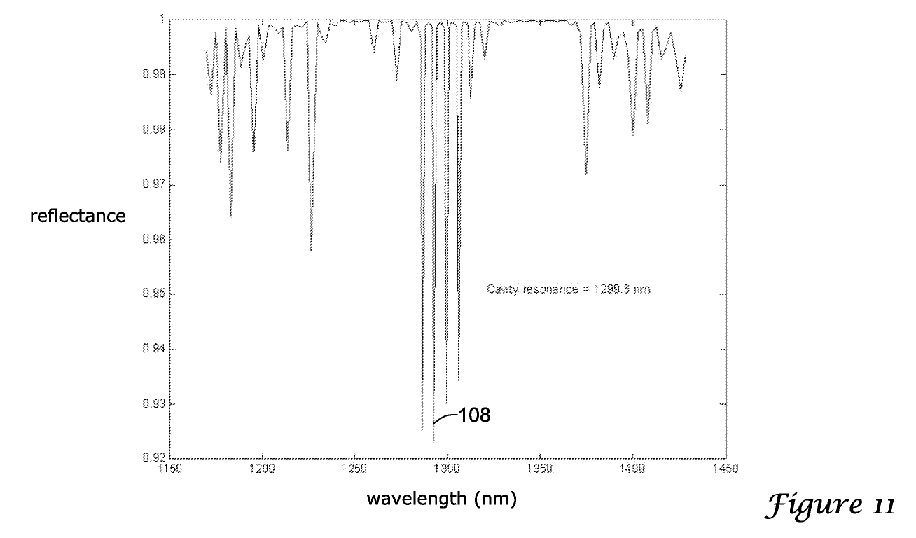

FIG. 11 shows reflectance versus wavelength. Curve 108 reveals the resonant cavity reflectance for the VCSEL 80, in the aperture. The cavity resonance may be determined to be about 1299.6 nm.

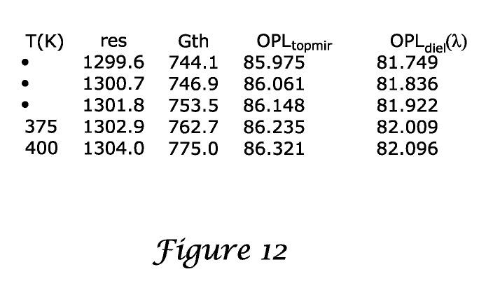

FIG. 12 shows a table with temperature in Kelvin (K) degrees, and data about the cavity resonance, the Gth, OPLₜₒₚₘᵢᵣᵣₒᵣ and OPL_{dielectric}. The OPL of the Si spacer may increase about 0.1 λper 25°K., but its effectiveness in changing the Fabry-Perot (FP) cavity is reduced by the three AlGaAs periods immediately on the top of the active region 88. These periods were added to reduce the effective cavity length and thus spread the FSR.

The following items may be applicable to the structure of a cavity ring down system. They include the sealing of mirror to the cavity block using, for examples, frit, optical and sodium techniques. The attachment of a gas tube may involve indium and frit approaches. There may be an appropriate mirror-transducer design involving a web or thin characteristics. Shaping of cavity may be specific for a proper modal structure. Brewster windows may be utilized in the structure to prevent fouling of optics. A choice of block materials may be made to match thermal environment of various components of the structure. There may be ASICs to report out losses. The readout electronics may incorporate a low noise circuit or amplifier. The may be mass fabrication of cavity blocks.

The present system may utilize fabrication that has implements an approach for joining mirrors to a ring cavity system block. There appears to be a need to find a more cost-effective way to join and seal mirrors to ring cavity system blocks. Importantly, the seal should be a vacuum seal. One approach is to bond Zerodur™ mirrors to Zerodur™ blocks.

A vacuum sealing of a mirror may be to a ring cavity system block utilizing a liquid joining solution obtained from Schott Glass Technologies, Inc., may be used. Utilizing the liquid joining solution to couple/seal the mirror to the block appears to be quite cost-effective. Liquid solutions such as sodium silicate solutions, obtained from other sources, may be used, for sealing a mirror to the ring cavity block.

In one illustrative example, a provision may be made in the construction of laser block to establish a gap of thickness approximately in the range of 0.001 to 0.010 inches between the block and mirror surfaces to be joined. This gap facilitates and controls the “wicking” of the joining liquid into the desired joining region. The parts to be joined are then placed in the desired (position) relationship. Suitable fixturing may be employed to establish and maintain the desired positions. A small amount (one to several drops) of the joining liquid is then applied at one or more points at the circumference of the region where the parts are to be joined. The natural tendency for capillary movement then acts to transport the joining liquid to the desired joining region (the gap mentioned above).

Within a minute or two, the strength of the resulting bond between the laser mirror and block may be sufficient to allow handling. The assembly may then be placed into a chamber which is equipped to accomplish a curing of the joint by means of a controlled temperature and time schedule. Upon completion of the thermal cure, the joining process may be considered complete and the assembly is ready for continuation of the assembly process. Sodium silicate solutions may be used to provide vacuum seals between a mirror and the ring cavity block.

One may measure gas absorption spectra fairly rapidly using CRD spectroscopy. Ring down time measurements with CRDS may require analysis and mapping of the thermal decay profile over a number of cavity light fills to reduce S/N. A better technique, although not absolute, is to measure the intensity of the radiation coming from the cavity while it is continuously being pumped with a scanning laser. Prior calibration of the cavity with time decay to intensity correction factors may yield the overall absorption magnitude and hence gas concentration. From time to time, calibrations can be redone or when precise values are needed, ring down time can be noted.

A tunable laser beam may be introduced into the cavity and intensity data is taken over a period of time commensurate with the slew rate of the laser beam wavelength. The slew rate over spectral features of a laser linewidth of ˜0.1 nm should permit a scan rate of 1 nm/msec or 1 m/min, the full scan range. The intensity curve should be corrected for changes in optical transmission for the laser and the other optics. While the external laser is being scanned, the feedback to the mirror position may be activated to control the round trip path to an integer number of wavelengths to maximize the intensity measured by a laser intensity monitor (LIM).

A variation of the invention may include the absorption cell in an optical feedback loop that includes the laser (as an optical oscillator). That approach would open consideration of an alternative of using a linear, rather than a ring, absorption cell with the cell retro-reflection used as the feedback signal.

Cavity ring down work on laser mirrors can be done at times with intensity measurements. The cavity ring down may be an instrument which uses the intensity to map out spectra with an external laser that is being scanned.

A sealing approach for a cavity ring down system may be implemented here. A cavity ring down system may consist of an optical resonator. By sealing the system, contaminants should not adversely affect the resonator. A present approach may apply a sealing method consistent with compensating for bonding differing thermal expansion materials.

The sealing method may use indium metal to create a vacuum tight bond between two or more parts. An advantage of indium sealing is indium's ability to flex or flow to assist in thermal expansion mismatch between the components to be sealed.

Sealing in the system may utilize indium seals. A “wire” of indium may be placed on one part, and other part is pressed onto the first. Under pressure, the indium cold flows, it seals and bonds both surfaces. The sealing method may be applied to a cavity ring down system, for the fabrication of the cavity.

Optical contact seals may also be used for cavity ring down systems. Cavity ring down systems may contain an optical resonator. One approach to attach mirrors to make the optical resonator is a use of optical contacts. Optical contact seals are vacuum-tight, keep the mirrors aligned to the cavity, and are mechanically robust. Optical contacts are made by polishing the surfaces for bonding to an “optical” flatness. This flatness may quite precise. Bringing the two surfaces into contact immediately forms a bond. Other cavity ring down systems may have alternative methods for holding mirrors to the cavity, or the mirrors may even not be directly attached to the cavity.

A piezo transducer may be used in a cavity ring down system. Cavity ring down systems may contain an optical resonator. To tune the resonance of the cavity by changing the optical path length, a piezo driver may be used to move a mirror in the laser path. The resonator needs to be set at particular physical dimensions to make the cavity resonance occur. Due to thermal expansion, and due to the precision required of the dimensions of the light path, a piezo transducer may be used to circumvent such issues as thermal expansion. The piezo driver may fit in as an integral part of the cavity resonator.

Piezo electric transducers may come in several forms. They may change one or more dimensions upon an application of a voltage. By attaching a piezo stack, by gluing or other mechanical means, to a mirror, a position of the mirror reflective surface may be changed by the piezo stack thereby changing the optical path length in the resonator cavity. Other cavity ring down systems do not appear to use this approach for tuning the resonance of the cavity.

A low noise amplifier may be used in the present CRDS read out circuit. A design parameter of the amplifier may be about a 20 MHz with a gain of around 10e6. The amplifier may have unity gain at about 100 MHz. There may be a noise decreasing in the region of interest. Normal very high bandwidth amplifiers tend to be current feedback, and may be noisier than voltage feedback ones. Power might be traded for noise purposes. One might use a common base transistor to buffer the photodetector output (set up in a photo-conductive mode), followed by a transimpedance amplifier (i.e., a good high gain bandwidth low noise operational amplifier such as may be a TLC2226), followed by other op-amps to bump the resulting low voltage signal to defined levels for the present CRDS read-out. Since phase shift in the CDRS amplifier is not necessarily critical, one may drive the noise terms as a first priority. One may use composite op-amps (i.e., an op-amp in the feedback loop of the primary amp) to help mitigate phase and bandwidth issues. One may use ASICs with active components to avoid a higher resistor feedback configuration, and then use back-to-back diodes in the sub threshold range to provide high impedance, used to stabilize the amp (configured as an integrator.

It might be noted that a greater than 20 MHz bandwidth of the design is to be maintained while achieving low noise. Also helpful, using an A/D converter having a resolution greater than 8 bits. A 16 bit or greater may used so as to avoid domination by a digitization noise of an 8-bit A/D converter. Getting lower noise in the “tails” of the ring-down as a result of the circuitry noted herein may result in more accurate estimates of the slope (and thus the loss).

FIG. 13 is an example amplifier circuit 110 for the CRD readout. The device may be a dual N-channel JFET (junction-gate field-effect transistor) charge amplifier. A signal input 109 may be placed across a gate of a JFET 111 and a ground 113. A sense capacitor 114 of about 6 pF (IPG) may also be connected across the input of JFET 111 and ground 113. The drain of the JFET 111 may be connected through as 1 K ohm resistor 115 to a voltage source 117. Voltage source 117 may be about a 12 volt positive voltage DC. The source of JFET 111 may be connected through a 3 K ohm resistor 118 to a negative voltage source 119. Source 119 may be about 12 volts. A JFET 112 may have a drain connected through a 1 K ohm resistor 116 to the positive voltage source 117. The source of JFET 112 may be commonly connected with the drain of JFET 111 through resistor 118 to negative voltage source 118. The gate of JFET 112 may be connected to ground 113.

The drain of JFET 112 may be connected to an inverting input 121 of an operational amplifier 123. The drain of JFET 111 may be connected to a non-inverting input 122 of the amplifier 123. The non-inverting input 122 may be connected through a 75 ohm resistor and a 100 pF capacitor connected in series, to the ground 113. An output 126 of amplifier 123 may be connected through a 100 pF capacitor 127 and a 75 ohm resistor connected in series, back to the inverting input 121 of the amplifier 123. Also, the output 126 of amplifier 123 may be connected through a 1000 Meg ohm resistor 129 and a 2 pF capacitor 131 connected in parallel, back to the input gate of JFET 111.

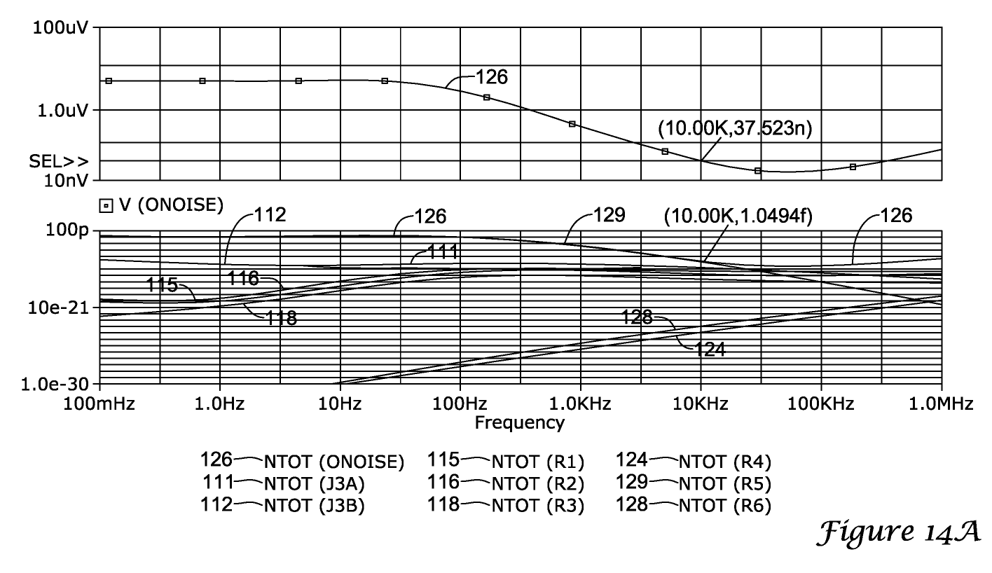

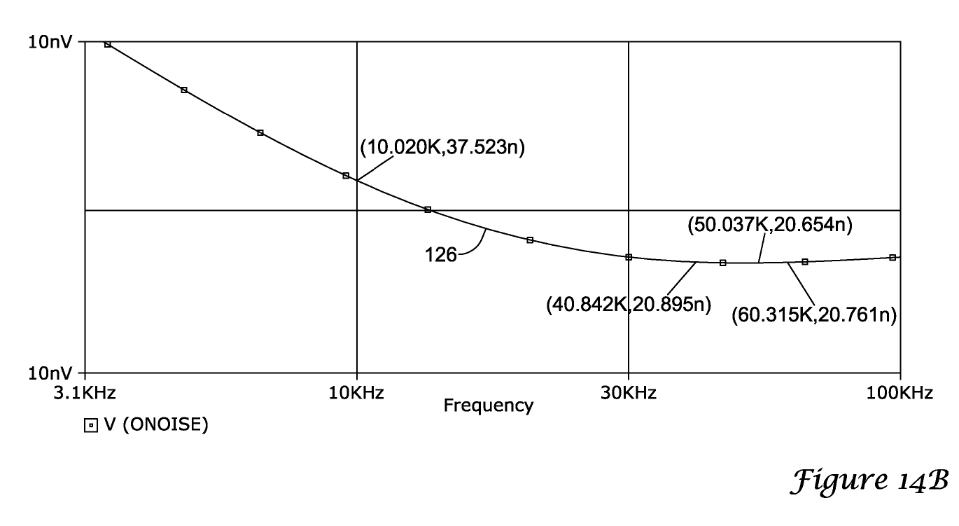

FIG. 14a shows a graph of noise versus frequency for amplifier circuit 110. A dominant noise is the noise of the feedback resistor 129. The total output 126 noise is about 37 nV/rootHz and the resistor 129 contribution is about 32 nV/rootHz. For a big size of the sensor capacitor 114 (i.e., 28 pF), the total output noise is about 44 nV/rootHz. FIG. 14bshows a graph of noise at output 126 versus frequency for amplifier circuit 110. The graph shows a minimum noise of about 20 nV/rootHz at around 50 KHz. Demodulation may be pushed to this frequency using an AC sense bias voltage.

Active noise cancellation may be implemented with amplifier 110. FIG. 15 shows an active cancellation circuit 135 with the amplifier. The sense capacitor 114 may be 100 pF, although higher than practical but usable in a simulation. The ground side of the signal input 109 and capacitor 114 of amplifier 110, in the schematic of FIG. 13, may be reconnected through a 10 K ohm resistor 136 to ground 113. An active noise cancellation circuit 135 may have a JFET 138 having a drain connected to the positive voltage source 117, a gate connected to the gate of JFET 111, and a source connected through a 1 μF capacitor to the common connection of input signal 109, capacitor 114 and resistor 136. Also, the source of JFET 138 may be connected through a 10 K ohm resistor 137 to the negative voltage source 119.

FIG. 16a is a graph showing the double JFET charge amplifier noise composition of the non-compensated circuit 110 of FIG. 13 (without the compensation circuit 135 as shown by bars 142), and the compensated circuit 110 of FIG. 15 (with the compensation circuit 135 as shown by bars 141). The bars show the noise (at 10 KHz [nV/rootHz]) versus the output and components 126, 111, 112, 138, 115, 116, 118, 124, 129, 128, 136 and 137, respectively. Comparing the output 126 noise with/without the cancellation circuit 135, the benefit is about 20 percent for a large sensing capacitor 114 (i.e., 100 pF).

FIG. 16b shows a graph of dB versus frequency of various gain factors for the amplifier 110 of FIG. 15. The graph shows a loop gain of about one (0 dB) at 100 MHz. At this frequency, there is about 36 degrees of phase shift. The graph also appears to reveal very good stability of the amplifier. FIG. 16c shows a graph of gain (dB) versus frequency for the amplifier of FIG. 15. The open loop gain may be about 116 dB and the −3 dB frequency is about 4 kHz. The input frequency (sense damping) is negligible. The input impedance may be given by Zᵢₙ˜((jωτ)/G₀)(1/(jωC_{f}))=τ/(G₀Gf)=32 ohms.

FIG. 16d is a table comparing simulated and actual measured noise levels from a breadboard version of the charge amplifier 110 of FIG. 13. The feedback resistor 129 used was 220 Meg ohm, in order to maintain baseline with other previous circuits tested (not discussed here). The noise level was measured at 10 KHz and 13 KHz (IPG and OPG) with out the noise cancellation circuit 135. According to the table of FIG. 16d, The PSpice (simulation) and measured noise levels for 10 KHz are 72 and 88 nV/rootHz, respectively. Corresponding levels for 13 KHz are 55 and 70 nV/rootHz, respectively. The actual ACB output noise value is about 240 nV/rootHz. Further improvement may be achieved with the active noise cancellation circuit 135 for reducing sense sensor capacitance and stray capacitance. Implementing the circuit 110 in a printed circuit board (PCB) should add more improvement.

A mirror mounting device 310 and approach for beam path alignment of a system 312 is illustrated generally in FIG. 17. The system 312 includes a system frame or block 314. The block 314 is generally triangular shaped with a hexagonal outer periphery. The shapes could be square, pentagon-like or other, along with various shapes for the periphery. The hexagonal outer periphery includes three planar non adjacent sides that form first, second and third mirror mounting surfaces 316, 318 and 320, respectively, and three further planar non adjacent sides 321, 322 and 323, respectively. The mounting surfaces 316, 318 and 320 and sides 321, 322 and 323 form a border for planar top and bottom surfaces 324 and 326 (see FIGS. 20-22), respectively, of the block 314. The block 314 is centered about an input axis 328 (which is perpendicular to top and bottom surfaces 324 and 326) within a circular inner boundary 330 of the block 314. The block 314 is formed of a glass ceramic or like material. Suitable block materials include the glass ceramic material marketed under the trademarks “Cervit” and “Zerodur”. A suitable glass material is marketed under the trademark “BK-7”.

As seen in FIG. 17, an internal optical cavity 332 of the block 314 comprises three substantially straight bores 334, 336 and 338, respectively that are interconnected at the mounting surfaces 316, 318 and 320 by three cylindrical shaped wells 340, 342 and 344, respectively. The block 314 may be solid and then machined to accommodate various shapes, channels, holes, bores, and spaces for operational aspects or for placement of components. The bores 334 and 336 include apertures 335 and 337, respectively that define a desired closed loop optical path. The bores 334, 336 and 338 and the wells 340, 342 and 344 are bored within the block 314 to form the triangular shaped closed loop optical path, with the mounting surfaces 316, 318 and 320 located at corners of the optical path.

As seen in FIG. 17, two planar mirrors 358 and 360, respectively, having flat reflective surfaces 361 and 362, respectively, are secured (for example, via optical contact, epoxy bonding or fritting) to the second and third mirror mounting surfaces 318 and 320, respectively. A curved mirror 363, having a concave reflective surface 364 is secured (via epoxy bonding or fritting) to the mirror mounting device 310 associated with the first mirror mounting surface 316. The reflective surfaces 361, 362 and 364 of each of the mirrors 358, 360 and 363 reflects the light beam(s) 346 at its respective corner of the closed loop optical path defined by the optical cavity 332.

As seen in FIGS. 17-22, the mirror mounting device 310 includes a circular shaped channel 366 formed in the block 14 at the first mounting surface 316. The cylindrical well 340 is surrounded by the circular channel 366. As seen in FIGS. 18-21, the circular channel includes inner and outer concentric sidewalls 368 and 370, respectively, and a bottom wall 372. The inner and outer sidewalls 368 and 370 may, as shown, be perpendicular to the first mounting surface 316; however, perpendicularity is not necessarily essential here. The intersection of the inner sidewall 368 and the first mounting surface 316 defines a circular edge surface 374 of the mounting device 310. The concave reflective surface 364 of the curved mirror 363 engages and is secured to the edge surface 374 of the mounting device 310. In practice, the circular channel 366 is machined, such as by milling, into the block 314. In one illustrative example, the circular channel has a width of 0.155 inches between the inner and outer sidewalls 368 and 370, and a depth to the bottom wall 372 from the first mounting surface 316 of 0.008 inches.

As seen in FIGS. 18 and 19 (these figures illustrating two different positions of the curved mirror 363 relative to the first mounting surface 316 and the mounting device 310), an angle of egress 376 and an angle of ingress 378 relative to a line 380 tangent to the concave reflective surface 364 at a point of reflectance 381 of the light beam(s) 346 reflected by the curved mirror 363 are always substantially the same angle, irrespective of the position (i.e., orientation) of the curved mirror 363 relative to the first mounting surface 316 or the mounting device 310. For example, for the system 312 which is shaped like an equilateral triangle, the angles of egress and ingress 376 and 378 will be substantially 60 degrees whatever the position of the curved mirror 363. For a square shaped system, as another illustrative example, the egress and ingress angles will be substantially 45 degrees. Described another way and depicted in FIGS. 20 and 21, a line 382 (line 382 being coincidental to laser light beams 346 in FIGS. 20 and 21) extending between the point of reflectance 381 and the input axis 328 of the block 314 is always perpendicular to tangent line 380 and input axis 328, irrespective of the position (i.e., orientation) of the curved mirror 363 relative to the first mounting surface 316 or the mounting device 310. The noted objectives may be accomplished as long as a substantial portion of the edge surface 374 engages the concave reflective surface 364 of the curved mirror 363. The edge surface 374 and channel 366 coact with the concave reflective surface 364 to automatically allow the curved mirror 363 to self-align in accordance with the above set forth parameters. This self-alignment coaction takes the form of the ends of the curved mirror 363 moving appropriately towards and away from the mounting surface 316 (as represented by double headed arrows 384 and 386 in FIGS. 18-21) to achieve the proper orientation of the curved mirror 363. Hence, in accordance with the mirror mounting device 310 and approach of beam path alignment, translating the curved mirror 363 relative to the first mounting surface 316 does not “steer” (i.e., redirect) the light beams 346 because the light beams 346 reflect off of the concave reflective surface 364 at the same angle no matter what the curved mirror's 363 position is relative to the first mounting surface 316. In accordance with the mirror mounting device 310 and the approach of beam path alignment, alignment of the laser light beams 346 within the closed loop optical path defined by the optical cavity 332, is a matter of placement of the mirror mounting device 310 relative to the first mounting surface 316. In other words, beam path alignment becomes a matter of block 314 geometry with positioning of the curved mirror 363 no longer a critical part of aligning the light beams 346 within the apertures 335 and 337 of the bores 334 and 336 of the optical cavity 332.

To compensate for the “tilt” (i.e., “block geometry errors”) of the mirror mounting surfaces 316, 318 and 320 relative to the planar top and bottom surfaces 324 and 326 of the block 314, the mounting device 310 is located on the first mirror mounting surface 316 in accordance with the equation:
d=r*α*4.85E−06 radians/arc-second
where

r=the radius of curvature (in inches) of a concave reflective surface 364 of the curved mirror 363,

α (see FIG. 24) is the pyramidal angle (in arc-seconds) of the mounting surfaces 316, 318 and 320 of the block 314, and

d (see FIG. 22) is the distance (in inches), relative to the internal optical cavity apertures 335 and 337 of the optical cavity 332 for the block 314, a center line 388 of the circular edge surface 374 of the mirror mounting device 310 is offset from a center line 390 of the internal optical cavity apertures 335 and 337 of the optical cavity 332.

As seen in FIGS. 23 and 24, the pyramidal angle α is defined by the angle at the intersection of a line 392 extending perpendicular from the first mounting surface and a plane 393 formed by intersecting lines 394 and 396 extending perpendicular from mounting surfaces 318 and 320, respectively. The dashed lines 397 in FIGS. 23 and 24 are normal to the top and bottom surfaces 324 and 326 of the block 314 and are used to help depict the “tilt” of the mounting surfaces 316, 318 and 320. The pyramidal angle α is a measurement determined in a manner by autocollimator technology. By determining the pyramidal angle α for a particular block 314, and knowing the radius of curvature r of the concave reflective surface 364 of the curved mirror 363, the offset distance d can be determined for proper placement of the circular channel 366 of the mirror mounting 310.

The following is an illustrative example. A measured pyramidal angle α of 80 arc-seconds and a radius of curvature r of 9.5 inches yields an offset distance d computed as (9.5 inches*80 arc-seconds*4.85E−06) 0.0037 inches or 3.7 mils. The sign of d is positive therefore the center line 388 of the circular edge surface 374 of the mirror mounting device 310 is offset (in the direction represented by arrow 398 in FIG. 22) 3.7 mils from the center line 390. An answer for d having a negative sign would of course result in movement of the center line 388 in a direction opposite to that represented by arrow 398.

An approach of beam path alignment using the mirror mounting device 310 may begin with measuring the pyramidal angle α of the mirror mounting surfaces 316, 318 and 320 of a particular block 314. The placement location of the mounting device 310 on the first mounting surface is then calculated using the equation d=r*a*4.85E−06. The calculated position of the mounting device 310 is then located on the first mounting surface 316 and the circular shaped channel 366 is machined by milling into the first mounting surface 316 to create the edge surface 374 that supports the curved mirror 363. The concave reflective surface 364 of the curved mirror 363 is then secured to the edge surface 374. The edge surface 374 automatically orients the concave reflective surface 364 of the concave mirror 363 such that the light beams 346 are aligned within the closed loop optical path (defined by the apertures 335 and 337 of the optical cavity 332), and the light beams are at their maximum intensity irrespective of the position of the concave mirror 363 relative to the first mounting surface 316.

This mounting device 310 and approach for beam path alignment reduces the amount of the mirror handling needed to align the light beams 346 within the optical cavity 332. Mirror handling is substantially reduced because the other approaches of translating the curved mirror about its mounting surface to identify the mirror's optimum mirror mounting position are unnecessary. Therefore, this mounting device 310 and approach decreases the likelihood of mirror reflective surface damage and/or contamination during alignment, and therewith decreases the number of systems needing to be rebuilt or scrapped. In addition, this mirror mounting device 310 and approach is relatively easy and inexpensive to practice and greatly facilitates automation of assembly operations.

The cavity blocks described herein may have gas or fluid input tubing and output tubing. Other conveyance mechanisms may be used.

Mirrors 416 and 418 may be commonly joined to block 412 by an optical contact, or frit seal. The stability of the seal is particularly critical since the laser beams therein need to traverse a polygonal ring path. The path may be a series of bores or bored holes in the material connected from end to end so that light may propagate through them in a continuous manner around a closed path in a repetitive fashion before the light is dissipated. Therefore, alignment of the mirror surfaces, at least three, relative to each other, is critical so that an optical closed loop path may be established as defined by the mirror surfaces. Of course, if a frit seal is chosen as an approach for attachment of the mirror component to the laser block, the coefficient of thermal expansion of the frit material should be as chosen to be as close as possible to both the mirror component as well as the laser block so that alignment of the mirrors is minimally altered by temperature effects.

The term “frit” is intended to mean any of a wide variety of materials which form a glass or glass-like seal, such materials being either vitreous or non-vitreous. Such frit materials may include other elements, for example, a lead-glass or the like. Frit materials, their corresponding coefficient of thermal expansion properties and their fritting temperatures, may be obtained from Corning Glass Works and Schott Optical Glass Company. Examples of frit materials suitable for use with a laser block and mirror substrate built from a borosilicate glass may include BK-7 glass, from Coming Glass Works, having a coefficient of thermal expansion of 8.3×10E−6/degree C. are Coming 7570 vitreous frit material having a coefficient of thermal expansion of 8.4×10E−6/degree C., Corning 7575 vitreous frit material having a coefficient of thermal expansion of 8.9×10E−6/degree C., and Schott G017-340 having a coefficient of thermal expansion of 8.3×10E−6/degree C.

Illustrated in FIGS. 26a, 26b, and 26c is an illustrative example for attaching mirror component 416 to block 412, like those components illustrated in FIG. 25, by use of a “frit preform” 200. FIGS. 26a and 26b illustrate the assembly of the mirror component 416 to block 412 prior to the “fritting process”, and FIG. 26c illustrates the attachment of the mirror component 416 to block 412 after the fritting process. More specifically, FIGS. 26a and 26b illustrate a ring-shaped frit preform 200 having an aperture therethrough. Mirror 416 includes a mirror coating (not shown) to be in communication with cavity 414. Mirror 416 is illustrated as being cylindrically shaped, and being disposed within the aperture of preform 200.

FIG. 26c diagrammatically illustrates the resulting frit seal 200a after the combination of the mirror 416, block 412, and frit preform 200 have been heated to the fritting temperature, and subsequently cooled to form the glass frit seal. At the fritting temperature, the frit material changes to a liquid state. The components as illustrated in FIGS. 26a and 26b are held in place by an adhesive.

With the adhesive, the process to hold the frit preform 200 in place can be performed on a non-horizontal surface while the frit seal 200a forms. This process is performed by tacking the frit preform 200 in place with adhesive so that no fixturing is required. The frit preform 200 is tacked by a material that has a capability to bind in volatile matrix solvents such as a lacquer. The tacking material is placed on the surface to form a film. This holds the frit preform 200 lightly against the block. A benefit to the non-horizontal process is that manufacturing could be performed in a much less complex manner by forming multiple frits at one time rather than forming one frit at a time. A benefit to the use of the tacking material is that it burns off completely after the heating process. Therefore, no residue or debris is left that would contaminate or add stress to the frit seal 200a.

After the fritting process, the combination as noted herein is allowed to cool, resulting in a hermetic frit seal 200a surrounding the peripheral junction 220 of mirror 416 and laser block 412. The use of the ring shaped preform 200 may result in the frit preform 200 “shrinking” around the junction 220 of the mirror 416 and block 412 during the fritting and wetting process thereby enhancing the seal over that of using a frit/slurry.

The dimensional aspects of mirror 416: and preform 200 may have wide variations. An illustrative example may be one in which preform 200 has an outside diameter of 0.398 inches, inside diameter of 0.320 inches, and having a thickness of 0.035 inches; and mirror component 416 is composed of BK-7 glass having an outside diameter of 0.300 inches.

It should be noted that frit preform 200 consists generally of a frit material held together by any of a variety techniques. For example, Corning Glass Works provides a product under the trademarks of “Multiform and Clearform”. These products are intricate non-porous, vacuum tight bodies of pressed glass made by the “powder processing” of glass. Granulated glass particles are dry-pressed into shape and fired at high temperature to fuse them into a tight shaped structure. Other types of preforms may be utilized including sintered glass preforms, as well as those preforms held together by a “wax-like” binder for maintaining the preform shape. The use of the preforms as noted herein permits the fritting process requiring only one heating step, the temperature being only sufficient to cause the frit material to change to a liquid state.

The description of the illustrative examples with reference to FIGS. 26a, 26b, and 26c are applicable to any component other than mirror component 416 being attached to block 412.

The Figures noted herein generally depict components as articles which are mounted to another article shown as block 412. The Figures, furthermore, generally depict an article which has an annular or ring-shaped mounting surface which when joined to the block form an annular junction between the component and the block. It is intended that components other than having an annular mounting surface may be used.

The frit preforms illustrated in the accompanying drawings have also been shown to be ring-shaped construction. When such ring-shaped preforms are applied around components which are also annular, the frit process lends itself to the frit preform shrinking around the peripheral junction of the component to the block as a result of the fritting process. Although a ring shape preform is noted, other shapes, for example, rectangular-shaped preforms, may be used since they too will provide wetting and shrinking around the junction of the component and the article which is intended to be joined thereto.

FIG. 27 shows a ring cavity system log 510. Log 510 is formed of a glass, glass ceramic, or like material. Suitable log materials include the glass ceramic material marketed under the trademarks “Cervit” and “Zerodur”. An example of a suitable glass material is a borosilicate glass marketed under the trademark “BK-7”.

The cross section of log 510 is generally triangular shaped with a hexagonal outer periphery. The hexagonal outer periphery includes three planar non-adjacent sides that form first, second and third mirror mounting surfaces A, B and C, and three further planar non-adjacent sides F, G and H.

To form individual systems, log 510 is drilled, or machined, with various internal passages and bores and then sliced into individual blocks 512. However, before such machining is accomplished, the measurement approach may be employed to determine the optimal location for machining a mirror mounting device for a concave mirror.

When log 510 is to be machined, it is mounted on supports so that machining operations can be accomplished by a computer-controlled machining device. One such device may be a CNC (computer numerical control) machine. However, the turning axis of the supports does not usually coincide exactly with the true center of log 510. One approach may accurately position a concave mirror mounting device despite that discrepancy and compensates for any taper or curvature of the log.

After log 510 is mounted on the CNC machine, several points along the x axis are selected as measurement points. The more points are selected, the more accurate the resulting offset determinations will be for each block 512. As shown in FIG. 28, twelve blocks will be cut from each log 510, and 513 points along the x axis of log 510 are selected for measurement.

FIG. 29 is a diagram illustrating an approach where the turning axis of the supports 514 does not coincide with the true center 516 of log 510. Center 516 is defined as the center of the circle 518 which is tangent to mirror mounting surfaces A, B and C. Measurement “a” is the distance from axis 514 to side “A.” Measurement “b” is the distance from axis 514 to side “B.” Measurement “c” is the distance from axis 514 to side “C.”

The coordinate system originates at center 516. The x axis, shown in FIG. 27, runs through center 516 along the length of log 510. The Y & Z axes, shown in FIG. 29, exist in a plane perpendicular to the x axis. The Z axis is perpendicular to side A. The Y axis is parallel to side A and perpendicular to the Z axis. The U axis is defined by the numerical control system of the CNC machine and is independent of the X-Y-Z coordinate system. The relationship between the points on the U axis may be noted in the equation, U_{c}=(U₁+U₂)/2.

For each chosen position along the x axis, surface radial distances a, b and c are measured from the “front” of log 510, as shown in the top portion of FIG. 29. Then, log 510 is rotated 180 degrees. Surface radial distances a, b and c are then measured from the “rear” of log 510, as shown in the bottom portion of FIG. 29. The “front” and “rear” numerical values on the U axis are used to calculate the distances a, b & c. For example, as shown in FIG. 29, a=(U₂−U₁)/2.

Let “j” be the angle formed by the intersection of the planes defined by surfaces A and B. Let “k” be the angle formed by the intersection of the planes defined by sides A and C. Let R be the radius of circle 518. Let (Y, Z) be the coordinates of turning axis 514 relative to center 516. Then,
R=[a*sin k]+[b*sin j]+[c*sin (j+k)]sin k+sin j+sin (j+k).
In the simple case where j=k=60 degrees, the following relations result.
R=(a+b+c)/3
Y=(b−a)/sqrt(3)
Z=(a+b2c)/3
R is calculated for each of the points selected along the length of the log (the x axis).

The radius (R) measurements taken above are doubled to find the diameter (D) of circle 518 at each selected point x along the length of the log. The resulting data is then used to determine a best-fit curve to describe the diameters as a function of position along the log. Virtually any numerical analysis approach may be used. As an illustrative instance, a second-order quadratic equation may be used. Taking a derivative of this function, the slope can be determined, which describes the net taper or curvature of the three surfaces A, B & C to which the mirrors will later be mounted.

The quadratic equation may take the following form.
D(x)=D₀+1.5*(αx+βx²).

FIG. 30 explains how the factor of 1.5 is derived. Log 510 is placed in V-block 520, which has an apex angle 522 of 60 degrees, so that two of the mirror mounting sides A, B, or C rest on the planar surfaces of V-block 520. Circle 518 presents the circle which is tangent to sides A, B, and C at or near one end of log 510. Circle 518′ presents the circle which is tangent to sides A, B, and C at or near the opposite end of log 510. The difference in the elevation of the opposite ends of log 510 in V-block 520 indicates the taper of the log, which affects the ultimate offset needed for a mirror mounting device for each block 512 that will be cut from log 510.

Radius R of circle 518 forms one side of a right triangle, where the angle opposite R is 30 degrees. By trigonometric functions, the hypotenuse of the right triangle is 2R. Twice the radius of circle 518, or 2R, equals D, the diameter of circle 518: 2 R=D. Similarly, radius R′ of circle 518′ forms one side of a right triangle, where the angle opposite R′ is 30 46 of 65 degrees. By trigonometric functions, the hypotenuse of the right triangle is 2R′. Twice the radius of circle 518′, or 2R′, equals D′, the diameter of circle 518′:2R′=D′.

The distance from the top of circle 518 to apex 522 is 3R because it is the distance of hypotenuse 2R plus one radius. By simple multiplication of both sides of the 2R=D equation, 3R=1.5D. Similarly, the distance from the top of circle 518′ to apex 522 is 3R′ because it is the distance of hypotenuse 2R′plus one radius. By simple multiplication of both sides of the 2R′=D′, equation, 3R′=1.5D′. By subtraction, the difference in the elevation of the opposite ends log 510 in V-block 520 is 1.5D′−1.5D=1.5 (D′−D). Thus, the block dimension relating to a V-block measurement of pyramidal angle is 1.5 times the diameter difference.

The α and β values of the quadratic equation are then used to calculate the appropriate offset for the mirror mounting device on a block-by-block basis along the log. The equation for the offset at each point x along the log follows.
offset(x)=−1,500*r*(α+2βx)
where

offset(x) is in units of mils;

r is the radius of curvature (in inches) of a concave reflective surface of the curved mirror; for an illustrative example, r=9.5 inches;

x is the distance of the selected point from the end of the log (in inches); and

−1,500 comes from multiplying 1.5 by −1000. The factor of 1000 converts the units from inches to mils, and the negative sign indicates that the direction of the offset is opposite the direction of the slope of the mirror mounting surface (the mirror is shifted “downhill”).

Once the offset for each block is calculated, the mirror mounting device for the concave mirror for that block can be machined into the block at the proper location.

FIG. 31 is a perspective view of a system block showing a mirror mounting device. Mirror mounting device 524 is offset along the x axis (either in the positive or negative direction indicated by arrow 532) relative to the centerline S-S of the optical cavity of each block 512. Mirror mounting device 524 comprises recessed moat 526 machined into mirror mounting surface A. Such machining results in ring 528, formed interior to moat 526. The interior edge of ring 528 is defined by well 530 into the interior of block 510. The exterior edge of ring 528 is defined by the interior edge of moat 526. The face surface of ring 528 is co-planar with the surfaces of planar side A. In comparison, the surface of moat 526 is below the surfaces of ring 528 and side A. The exterior edge of ring 528 defines mirror alignment device 524, and it is on this edge that the concave reflective surface of the curved mirror rests. Because of the offset of moat 526, and therefore the offset of mirror mounting edge 524, ring 528 may not be uniform in width along its circumference.

One advantage of the present approach is that it allows the entire process to be accomplished by one machine. Because many CNC machines have precision measurement capabilities, the entire process: measurement, fitting of the quadratic equation, calculation of the offsets, and machining of the log, may be achieved under CNC computer control. This scheme avoids issues of confusion over communication of measurement results between different machines or operators.

The process is also capable of positioning the mirror mounting device to compensate for any irregularities in the log, such as linear taper or curvature of the log, or tilt of the critical mirror mounting surfaces. This allows the CNC machine to position the mirror mounting device on a block-by-block basis within the log, thereby increasing the accuracy of machining for each laser system. This approach may lead to significant economic savings because fewer parts will need to be rejected because of such irregularities.

A approaches for attaching and sealing components to ring cavity system blocks may use a process that requires temperatures only somewhat higher (if at all) than room temperature, and that produces long-lasting hermetic seals that can withstand high temperatures. These advantages can be realized by allowing a fluid or gel adhesive to wick into the component-to-block interface. One adhesive that can be used is an aqueous sodium silicate, which hardens into a glass-like bond as water in the solution evaporates. Another possible adhesive is an aqueous silica sol-gel, which forms a bond similar to that of an aqueous sodium silicate. As used herein, the term “adhesive” may mean any fluid capable of wicking into an interface and hardening, by whatever means, thus producing a bond.

Devices and approaches indicated herein may be used for achieving beam path alignment of an optical cavity with a measurement approach to facilitate production of a self-aligning laser system block.

FIG. 32 shows a simplified cross-section of one form of ring cavity block assembly. For purposes of illustration, some components of the block assembly that may be useful for operation, but not necessarily essential, are not shown in the Figure. A system body 610 is generally triangular but may have another geometrical pattern. The system body 610 may be formed of a glass or glass-like material, and have a low CTE (coefficient of thermal expansion). Suitable body materials include the glass ceramic material marketed under the trademark names “Cervit” and “Zerodur”. A suitable glass material is marketed under the name “N-BK-7”. Passages within the system body link openings in the body at each corner. The corners of the body may be truncated to provide mating surfaces 612, 614, and 616 for a component at each corner. As will be described below, the mating surfaces 612, 614, and 616 might not necessarily be completely planar.

The opening at each corner allows optical communication between components. The sides of the system body provide three remaining mating surfaces 618, 620, and 622. In the system shown, mating surfaces 612, 614, and 616 have mirrors 624, 626, and 628, respectively, attached. Mirrors 624, 626, and 628 may be comprised of Zerodur or another suitable material. In a ring cavity system, two of the mirrors may be concave, and the third (readout) mirror may be flat.

Mirrors and other components can be attached to the ring cavity system body or “block” by allowing fluid adhesives to wick into interfaces between the components and the ring cavity body. The components and block may be held at a controlled gap distance to improve wicking, although a gap may not always be necessary; for example, if mating surfaces are etched rather than polished, fluid adhesive may readily wick into the interface even if the component and ring cavity block are held together.

FIG. 33 shows in detail mirror 624 in mounting position relative to ring cavity block 610, although the following description is applicable to any other components that may be attached to a ring cavity block. A mirror mounting device 636 may be used to position a mirror optically and to establish a “wicking gap” into which adhesive can wick or flow due to capillary action. Mirror mounting device 636 may be offset relative to the centerline of the opening 638 and may also be positioned so as to compensate for any irregularities in the ring cavity block, such as linear taper or curvature, or tilt of the critical mirror mounting surfaces. Mirror mounting device 636 can be machined into the truncated corner(s) of block 610 using a CNC machine. The recessed portion or “moat” of mirror mounting device 636, which comprises the block mounting surface of interface 640, is machined into mounting surface 612, resulting in a raised ring 642 formed interior to the moat. Mirror 624 may be flat or concave, although if concave it would still appear largely as illustrated due to the relatively large radius of curvature. The height of ring 642, and thus the corresponding wicking gap at interface 640, can be about 0.001 inches to about 0.010 inches, although other gaps (e.g., at least as small as 0.0001 inches and as large as about 0.015 inches) are possible. To reduce chipping, mirror 624 may include a chamfer at the outer edge as shown. For example, the chamfer may be a 45 degrees chamfer at a distance of 0.010 inches from the edge of mirror 624. A chamfer may improve the wicking action that carries fluid into interface 640.

To attach mirror 624 to ring cavity block 610, the mirror may be placed into its final position (i.e., it is optically aligned) and held against raised ring 642, thus establishing a gap at interface 640 between the block and the mirror. With the mirror in position, a quantity of fluid solution may be applied using a small dauber or other device at one or more points around the circumference of mirror 624, indicated generally as interface 640. Capillary action or “wicking” then carries the fluid into the interface. Within a short time (a few minutes if using aqueous sodium silicate or aqueous silica sol-gel), the bond may be strong enough to allow careful handling. optionally, an infrared heat lamp placed at a distance of about 8 inches from the bond may be used for about 2 minutes to “initially” cure the fluid adhesive. Microwave or other forms of radiation may also be used to initially cure the fluid adhesive.

If more components are to be attached to the ring cavity system block, the above steps can be repeated until all components are in place and initially bonded to the ring cavity block, at which point the entire assembly can be baked at about 140 degrees F. for about 4+/−1 hours prior to further processing of the ring cavity system.

FIG. 33a illustrates a mirror 624 after it has been bonded in place as described above. Cured adhesive 644 attaches and seals mirror 624 to ring cavity block 610. It is to be expected that some fluid adhesive will also have wicked into the interface between raised ring 642 (see FIG. 33) and mirror 624, depending on the finish of the interface surfaces.

FIG. 33b illustrates another illustrative example where mirror 624 is bonded to a surface of ring cavity block 610 that does not have a mirror mounting device (i.e., the mounting surface 612 is substantially planar). The approach for this bond is the same as described above with reference to FIGS. 33 and 33a, although the structure is slightly different. The approach may be the same because fluid adhesive can wick into the component-to-block interface even without an established wicking gap, and cures to form a bond, as illustrated by cured adhesive 644 (the thickness of which is exaggerated for purposes of illustration). The mating surfaces may be etched with etchants such as ammonium biflouride, hydrogen fluoride, and others. As with the approach of FIG. 33, a chamfer on the outside edge of the component's mounting surface may also improve wicking.

FIG. 34 shows a sensor system 710 having a ring cavity 711. The cavity may be fabricated, formed or machined, or the like from one or several pieces of solid material. A light source 712 may emit a beam of light 713 into cavity 711. The beam of light may follow a path 714 of the cavity 711. Here, the light may propagate in a counterclockwise direction from the perspective of looking into the plane of the sheet of the Figure. A detector 715 may be proximate to where light 713 entered the cavity 711 from source 712. Source 712 may, for example, be a tunable laser.

At the corners of cavity 711, there may be mirrors 716, 717 and 718. Mirror 716 may partially reflect light 713 in the cavity so that detector 715 may detect some light in the cavity for analysis purposes. On mirror 716 may have a small hole for input and output for light 713. In this case, the mirror 716 may be fully reflective. Detection of light 713 may note intensity versus time, frequency, and other parameters as desired. The output of the detector or monitor 715 may go to a data acquisition and analysis circuit 719 for such things as acquisition, analysis and other purposes for obtaining information about a sample fluid in the cavity 711. One purpose may be for tuning the laser 712 to an adsorption line of the sample. The detector output to the readout and control electronics 721 may be improved with a dual JFET amplifier 110 described herein. Other circuits may be utilized for detector output processing. Readout and control electronics 721 may provide an excitation and control for light source 712. Inputs and outputs may be provided to and from a processor 722 relative to connections between the processor 722 and readout and control electronics 721 and data acquisition and analysis circuit 719. Processor 722 may also be connected to the outside 723 signals going in and out of system 710. A user interface may be effected with the readout and control electronics 721 and/or the outside 723. Readout and control electronics 721, data acquisition and analysis circuit 719, and processor 722 may constitute an electronics module 724. Electronics module 724 may have other components. Ports 725 may provide for input and output of a sample fluid to and from the cavity 711.

FIG. 35 shows a sensor system 720. Sensor system 720 is similar to sensor system 710 except that this Figure reveals an adjustable mirror 726 and Brewster windows 727. The adjustable mirror 726 may be connected to control electronics 721. Mirror 726 may have a piezoelectric layer between the mirror and the mirror mount attached to cavity block 711. As a signal is applied to the piezo electric layer, the layer may expand or contract and thus change the optical path 714 length in the ring cavity 711 for tuning purposes. Other mechanisms may be used to adjust mirror 726. Windows 727 may be situated in the tunnel, bore or channel for optical path 714. The windows 727 may provide a sealed space or compartment 728 for holding a sample fluid to be sensed. The sample fluid may be placed in and/or removed from compartment 728 via port or ports 725. Compartment 728 may be sealed from the remaining portions of channels, bores or tunnels for optical path 714. There remaining portions of channels, bores or tunnels may be sealed from the ambient environment external to the cavity 711, and may have a vacuum. The systems of FIGS. 35-38 may or may not have compartments 728. Other types or kinds of partitions or windows 727 may be implemented.

FIG. 36 shows a sensor system 730 that may be similar to systems 710 and 720. This Figure reveals a second light source or laser 732 and a second detector/monitor 733. Laser 732 may emit a light beam 731 into cavity 711 via mirror 718, which might be partially reflective or have a hole in it and be fully reflective. Light 731 from light source laser 732 may follow light path 714 in a clockwise direction which is the opposite direction of light beam 713 from laser or light source 712. Detector or monitor 733 may detect some of the light 731 as it exits cavity 711 via mirror 718 in the same manner as light 731 enters cavity 711. Laser 732 may be connected to control electronics 721 and photo detector or light monitor 733 may be connected to readout electronics 721. The dual beam approach may provide for better sensitivity and analysis of a sample fluid.

FIG. 37 shows a sensor system 740 that may be similar to systems 710, 720 and 730. This figure reveals a second adjustable mirror 734. Adjustable mirror 734 may improve a tuning range of cavity 711 by further adjustment of the length of optical path 714. Adjustable mirror 734 may be connected to control electronics 721 and be operated in a similar manner as adjustable mirror 726.

FIG. 38 shows a sensor system 750 that may be similar to systems 710, 720, 730 and 740. This Figure reveals a third adjustable mirror 735. Adjustable mirror 735 may improve a tuning range of cavity 711 by further adjustment of optical path 714. Adjustable mirror 735 may be connected to control electronics 721 and be operated in a manner similar to that of adjustable mirrors 726 and 734. As for light 713 and 731 entering and exiting cavity 711, adjustable mirrors 735 and 734 may operate similarly as mirrors 716 and 718, respectively.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A sensor system comprising:
a cavity having a ring-like optical path for light propagation;
a tunable laser source for providing light into the optical path of the block cavity; and
a detector for detecting light in the block cavity; and
wherein the cavity is a block of material comprising a plurality of bores connected end to end as the ring-like optical path in the block.

2. The system of claim 1, further comprising:
readout electronics connected to the detector; and
wherein the readout electronics comprise a dual JFET charge amplifier.

3. The system of claim 1, further comprising:
control electronics connected to the tunable laser; and
a data acquisition and analysis circuit connected to the detector.

4. The system of claim 1, further comprising mirrors situated where the bores are connected end to end.

5. The system of claim 1, further comprising a conveyance device connected to the cavity for conveying a gas to and/or from the cavity.

6. The system of claim 1, further comprising:
a first window situated at a first position in a portion of the optical path; and
a second window situated at a second position in the portion of the optical path; and
wherein the first and second windows provide a compartment in the optical path sealed off from the rest of the optical path.

7. The system of claim 6, wherein the compartment is for holding a sample fluid to be analyzed.

8. A sensor comprising:
a ring cavity having an optical path;
a light source optically connected to the optical path;
a detector optically connected to the optical path; and
a set of windows situated in the optical path to form a compartment in the optical path.

9. The sensor of claim 8, wherein the windows are Brewster windows.

10. The sensor of claim 8, further comprising a conveyance mechanism connected to the compartment.

11. The sensor of claim 8, further comprising:
at least one mirror in the optical path; and
wherein the at least one mirror is adjustable for tuning the optical path.

12. The sensor of claim 11, wherein the at least one mirror is adjustable for tuning the optical path to an absorption line of a fluid in the ring cavity.

13. The sensor of claim 8, wherein:
the ring cavity is a solid block of material;
the optical path comprises two or more tunnels in the block.

14. The sensor of claim 13, wherein
a mirror is situated at the end of each two tunnels; and
at least one mirror is adjustable in position for tuning the optical path.

15. The sensor of claim 8, wherein the light source is tunable to an adsorption line of a sample fluid in the compartment.

16. A system for sensing comprising:
a cavity having a plurality of light paths proximately associated together as legs of a polygon;
a mirror situated at a pair of ends of each pair of light paths, for reflecting light from one light path to another light path; and
a light source for providing light into at least one light path;
a detector for detecting light from at least one light path; and
wherein the cavity is formed out of a block of material.

17. The system of claim 16, further comprising a pair of windows in at least one light path to form a space in the light path sealed off from the light path outside of the space and sealed off from the other light paths.

18. The system of claim 16, wherein at least one mirror situated at a pair of ends of a light path is adjustable for tuning the cavity.

19. The system of claim 17, wherein the light source is tunable to an absorption line of a sample fluid in the space in the light path.

20. The system of claim 18 further comprising:
control electronics connected to the at least one adjustable mirror situated at a pair of ends of a light path; and
readout electronics connected to the detector; and
wherein the readout electronics comprises a dual FET amplifier.
